(19) United States
(12) Patent Application Publication
(10) Pub. No.: US 2003/0091764 A1
(43) Pub. Date: May 15, 2003

(54) Plastic film, and shopping bag and garbage bag produced from the same

(76) Inventors: Yasuhiko Fujii, Otake-shi (JP); Toshiki Matsui, Hiroshima-shi (JP); Minoru Ohsugi, Hiroshima-shi (JP); Kazuyuki Hayashi, Hiroshima-shi (JP); Mineko Ohsugi, Hiroshima-shi (JP); Hiroko Morii, Hiroshima-shi (JP); Tomoko Okita, Hatsukaichi-shi (JP)

Correspondence Address: NIXON & VANDERHYE P.C., 8th Floor, 1100 North Glebe Road, Arlington, VA, 22201, US

(21) Appl. No.: 10/128,584

(22) Filed: Apr. 24, 2002

(30) Foreign Application Priority Data
Apr. 27, 2001 (JP) 2001-132067
Jun. 11, 2001 (JP) 2001-175052
Jun. 12, 2001 (JP) 2001-177691

(51) Int. Cl. B32B 1/08; B32B 9/04

(52) U.S. Cl. 428/35.2; 428/35.7; 428/405; 428/447

(57) ABSTRACT

A plastic film which has a low hiding power and an improved heat resistance, and which exhibits an excellent color, is free from discoloration upon molding and shows a more excellent combustion efficiency upon incineration, and which comprises:

a thermoplastic resin and

fine composite pigments in an amount of 0.01 to 2.0% by weight, which have an average major axis diameter from 0.005 to less than 0.1 μm, and comprise:

iron oxide hydroxide particle as non-magnetic core particle,

a coating formed on surface of said iron oxide hydroxide particle, comprising at least one organosilicon compound selected from the group consisting of:

(1) organosilane compounds obtainable from alkoxysilane compounds, and

(2) polysiloxanes or modified polysiloxanes, and

an organic blue pigment coat formed on said coating comprising said organosilicon compound, in an amount of 1 to 20 parts by weight based on 100 parts by weight of said iron oxide hydroxide particles; and

a shopping bag and a garbage bag produced from such a plastic film.

### BACKGROUND OF THE INVENTION

The present invention relates to a plastic film, and a shopping bag and a garbage bag produced from the plastic film. More particularly, the present invention relates to a plastic film containing fine composite pigments (fine composite particles) containing no harmful elements such as Cr, Pb and Cd thereinto, which has a low hiding power and an improved heat resistance, and which exhibits an excellent hue, is free from discoloration upon molding and shows a more excellent combustion efficiency upon incineration, and a shopping bag and a garbage bag produced from such a plastic film.

The plastic film of the present invention can be mainly applied to shopping bags, garbage bags or the like.

Plastic films prepared by incorporating various pigments into a thermoplastic resin have been used in various applications such as shopping bags and garbage bags.

Specifically, in supermarkets, department stores and retail shops, printed and colored bags having corresponding logos or the like (hereinafter referred to merely as “shopping bags”) are generally handed over to customers at a cash desk. The shopping bags are used for taking out goods from the stores, and further are convenient for transporting various goods and enclosing various goods therein by tying an opening thereof since these bags usually have a carrying portion. As a result, the shopping bags have been reused as enclosures or garbage bags for household purposes.

In recent years, with changes of life style or rise in life level and income level, various new goods have been flooded in markets which results in rich material civilization, so that the amount of garbage discharged from individual homes are rapidly increased, thereby causing significant social problems concerning waste disposal treatments.

Upon the waste disposal, combustible wastes have been generally filled in a plastic garbage bag prepared by incorporating various pigments into thermoplastic resins such as typically polyethylene resin, and burned in an incinerator. Residual ashes and cinders produced after the incineration have been used for landfill.

Recently, commercial goods have been required to not only exhibit a high safety and good functions as essential properties thereof, but also be improved in visual, psychological and environmental properties. As a result, the shopping bags and garbage bags also tend to be required to have these improved qualities and properties.

More specifically, since the plastic shopping bags and garbage bags are produced by molding a resin at a temperature of not less than 200° C., color pigments contained in the resin film have been strongly required to show a high heat resistance. In particular, since the shopping bags are frequently used for putting foods or the like therein, it is required that the color pigments contain no harmful elements, from the standpoints of safety and hygiene.

Further, the plastic shopping bags and garbage bags have been strongly required to show an excellent color upon use from visual and psychological viewpoints.

The plastic shopping bags and garbage bags must be adequately discarded after use from environmental viewpoints. However, the incineration of combustible wastes enclosed in the plastic bags causes severe problems such as air pollution by NOx generated upon combustion thereof, lack of land to be filled-up with a large amount of residual ashes and cinders generated after the incineration, leakage of harmful substances contained in residual ashes or the like in the filled-up land, and production of harmful dioxin. Further, when the combustible wastes contain a large amount of plastic wastes or plastic garbage bags having a high combustion calorie, there arises such a problem that an inside temperature of the incinerator becomes too high upon combustion of the wastes, resulting in breakage of the incinerator.

Conventionally, as the plastic shopping bags and garbage bags having an enhanced combustion efficiency, those bags prepared by incorporating 0.1 to 20.0% by weight of ferric oxide hydroxide particles having an average major axis diameter of 0.02 to 2.0 μm or iron oxide particles having an average particle diameter of 0.03 to 1.0 μm into thermoplastic resins, have been already put into practice (Japanese Patent Nos. 2824203 and 2905693, etc.).

At present, it has been strongly required to provide a plastic film capable of not only exhibiting essential properties such as safety by incorporating thereinto pigments containing no harmful elements such as Cr, Pb and Cd, but also having a variety of color properties from visual and psychological viewpoints, for example, (i) excellent color or (ii) clear hue which is further free from discoloration upon molding and shows an excellent combustion efficiency upon incineration. However, plastic films fulfilling the above properties have not been obtained conventionally.

It is also known that plastic films into which pigments composed of fine particles having a particle size of less than 0.1 μm are incorporated, are transparent in a visible light range.

However, the fine pigments having a particle size of less than 0.1 μm have a large specific surface area and, therefore, generally tend to be deteriorated in heat resistance. For this reason, it has been strongly required that the pigments themselves can be improved in heat resistance.

Further, since the pigments are fine particles having a high surface energy, the fine pigments tend to be agglomerated together and, therefore, deteriorated in dispersibility in thermoplastic resins. As a result, the fine pigments tend to be agglomerated in thermoplastic resins so as to form coarse particles, so that it becomes difficult to obtain films having an excellent color.

Thus, it has been strongly required to improve dispersibility of the fine pigments in thermoplastic resins.

As a result of the present inventors' earnest studies for solving the above problems, it has been found that by adding to a thermoplastic resin fine composite pigments having an average major axis diameter of from 0.005 to less than 0.1 μm which comprise iron oxide hydroxide particle as a core particle, a coating layer formed on the surface of the iron oxide hydroxide particle, comprising organosilane compounds obtainable from alkoxysilane compounds, or polysiloxanes, and an organic blue pigment coat formed on the coating layer; and then molding the resultant resin composition into a film, the obtained plastic film can exhibit an excellent color, can be free from discoloration upon molding, and can show a more excellent combustion efficiency upon incineration. The present invention has been attained on the basis of this finding.

### SUMMARY OF THE INVENTION

An object of the present invention is to provide a plastic film capable of exhibiting an excellent color, i.e., an excellent transparency, being free from discoloration upon molding, and showing a more excellent combustion efficiency upon incineration for disposal.

Another object of the present invention is to provide a plastic film being free from deterioration in coloring effect of a colorant incorporated thereinto, showing an excellent color, and exhibiting an enhanced combustion efficiency upon incineration.

Another object of the present invention is to provide a plastic shopping bag or a plastic garbage bag having an excellent color.

A further object of the present invention is to provide a industrial and economical process for producing a plastic film capable of not only exhibiting a more excellent color, but also being free from discoloration upon molding and showing a further enhanced combustion efficiency upon incineration.

To accomplish the aim, in a first aspect of the present invention, there is provided a plastic film comprising:

a thermoplastic resin and

fine composite pigments in an amount of 0.01 to 2.0% by weight, which have an average major axis diameter from 0.005 to less than 0.1 μm, and comprise:

iron oxide hydroxide particle as non-magnetic core particle,

a coating formed on surface of said iron oxide hydroxide particle, comprising at least one organosilicon compound selected from the group consisting of:

(1) organosilane compounds obtainable from alkoxysilane compounds, and

(2) polysiloxanes or modified polysiloxanes, and

an organic blue pigment coat formed on said coating comprising said organosilicon compound, in an amount of 1 to 20 parts by weight based on 100 parts by weight of said iron oxide hydroxide particles.

In a second aspect of the present invention, there is provided a plastic film comprising:

a thermoplastic resin and

fine composite pigments in an amount of 0.01 to 2.0% by weight, which have an average major axis diameter from 0.005 to less than 0.1 μm, and comprise:

iron oxide hydroxide particle as non-magnetic core particle,

a coating layer formed on surface of said iron oxide hydroxide particle, comprising at least one compound selected from the group consisting of hydroxides of aluminum, oxides of aluminum, hydroxides of silicon and oxides of silicon,

a coating formed on the coating layer, comprising at least one organosilicon compound selected from the group consisting of:

(1) organosilane compounds obtainable from alkoxysilane compounds, and

(2) polysiloxanes or modified polysiloxanes, and

an organic blue pigment coat formed on said coating comprising said organosilicon compound, in an amount of 1 to 20 parts by weight based on 100 parts by weight of said iron oxide hydroxide particles.

In a third aspect of the present invention, there is provided a plastic film comprising:

a thermoplastic resin, a colorant of 0.01 to 2.0% by weight based on the weight of the thermoplastic resin, and

fine composite pigments in an amount of 0.01 to 2.0% by weight, which have an average major axis diameter from 0.005 to less than 0.1 μm, and comprise:

iron oxide hydroxide particle as non-magnetic core particle,

a coating formed on surface of said iron oxide hydroxide particle, comprising at least one organosilicon compound selected from the group consisting of:

(1) organosilane compounds obtainable from alkoxysilane compounds, and

(2) polysiloxanes or modified polysiloxanes, and

an organic blue pigment coat formed on said coating comprising said organosilicon compound, in an amount of 1 to 20 parts by weight based on 100 parts by weight of said iron oxide hydroxide particles.

In a fourth aspect of the present invention, there is provided a shopping bag produced from the plastic film comprising:

a thermoplastic resin and

fine composite pigments in an amount of 0.01 to 2.0% by weight, which have an average major axis diameter from 0.005 to less than 0.1 μm, and comprise:

iron oxide hydroxide particle as non-magnetic core particle,

a coating formed on surface of said iron oxide hydroxide particle, comprising at least one organosilicon compound selected from the group consisting of:

(1) organosilane compounds obtainable from alkoxysilane compounds, and

(2) polysiloxanes or modified polysiloxanes, and

an organic blue pigment coat formed on said coating comprising said organosilicon compound, in an amount of 1 to 20 parts by weight based on 100 parts by weight of said iron oxide hydroxide particles.

In a fifth aspect of the present invention, there is provided a garbage bag produced from the plastic film comprising:

a thermoplastic resin and

fine composite pigments in an amount of 0.01 to 2.0% by weight, which have an average major axis diameter from 0.005 to less than 0.1 μm, and comprise:

iron oxide hydroxide particle as non-magnetic core particle,

a coating formed on surface of said iron oxide hydroxide particle, comprising at least one organosilicon compound selected from the group consisting of:

(1) organosilane compounds obtainable from alkoxysilane compounds, and

(2) polysiloxanes or modified polysiloxanes, and

an organic blue pigment coat formed on said coating comprising said organosilicon compound, in an amount of 1 to 20 parts by weight based on 100 parts by weight of said iron oxide hydroxide particles.

In a sixth aspect of the present invention, there is provided a process for producing the plastic film as defined in the first aspect, comprising:

mixing a binder resin comprising a polyolefin-based resin with fine composite pigments in an amount of 1 to 43 parts by weight based on 100 parts by weight of the binder resin, which have an average major axis diameter from 0.005 to less than 0.1 μm, and comprise:

iron oxide hydroxide particle as non-magnetic core particle,

a coating formed on surface of said iron oxide hydroxide particle, comprising at least one organosilicon compound selected from the group consisting of:

(1) organosilane compounds obtainable from alkoxysilane compounds, and

(2) polysiloxanes or modified polysiloxanes, and

an organic blue pigment coat formed on said coating comprising said organosilicon compound, in an amount of 1 to 20 parts by weight based on 100 parts by weight of said iron oxide hydroxide particles, to produce master batch pellets; and

melt-kneading the obtained master batch pellets and a diluting binder resin comprising a polyolefin-based resin so that the content of the fine composite pigments in the plastic film become 0.01 to 2.0% by weight, and then forming into a film.

In a seventh aspect of the present invention, there is provided a plastic film having a thickness of 5 to 300 μm, a linear absorption of not more than 0.050 μm⁻¹ at a wavelength of 600 nm, a C* value of 0 to 18, a combustion velocity in air of not more than 2.5 minutes, a complete combustion percentage in air of not less than 90% by weight, and a low-temperature combustibility in air of not more than 510° C.;

which comprises:

a thermoplastic resin and

fine composite pigments in an amount of 0.01 to 2.0% by weight, which have an average major axis diameter from 0.005 to less than 0.1 μm, and comprise:

iron oxide hydroxide particle as non-magnetic core particle,

a coating formed on surface of said iron oxide hydroxide particle, comprising at least one organosilicon compound selected from the group consisting of:

(1) organosilane compounds obtainable from alkoxysilane compounds, and

(2) polysiloxanes or modified polysiloxanes, and

an organic blue pigment coat formed on said coating comprising said organosilicon compound, in an amount of 1 to 20 parts by weight based on 100 parts by weight of said iron oxide hydroxide particles.

### DETAILED DESCRIPTION OF THE INVENTION

The present invention is now described in detail below.

First, the plastic film of the present invention is described.

The plastic film of the present invention can be produced by molding a thermoplastic resin containing fine composite pigments in an amount of 0.01 to 2% by weight into a film.

The fine composite pigment (fine composite particle) used in the present invention, have an average major axis diameter of from 0.005 to less than 0.1 μm, comprises:

iron oxide hydroxide particle as a core particle,

a coating layer formed on the surface of the iron oxide hydroxide particle, comprising at least one organosilicon compound selected from the group consisting of:

(1) organosilane compounds obtainable from alkoxysilane compounds, and

(2) polysiloxanes or modified polysiloxanes, and

an organic blue pigment adhered on a part of the coating layer composed of the organosilicon compound.

The particle shape of the above fine iron oxide hydroxide particles used in the present invention is an acicular shape or a rectangular shape. Here, the acicular shape may include not only literally an acicular shape but also a spindle shape, a rice-ball shape or the like.

The fine iron oxide hydroxide particles may include goethite (α-FeOOH) particles and lepidocrocite (β-FeOOH) particles. In order to obtain fine composite pigments having a good heat resistance, the fine iron oxide hydroxide particles are preferably treated so as to impart a good heat resistance thereto. Specifically, as the fine iron oxide hydroxide particles, there may be preferably used fine iron oxide hydroxide particles whose surface is treated with an aluminum compound; fine iron oxide hydroxide particles into which aluminum is incorporated; fine oxide hydroxide particles having a composite oxide hydroxide layer containing aluminum and iron on the surface thereof; and fine iron oxide hydroxide particles obtained by subjecting to combination of the above heat-resistance-imparting treatments.

The fine iron oxide hydroxide particles whose surface is treated with an aluminum compound, have an aluminum content of usually 0.1 to 20.0% by weight (calculated as Al) based on the weight of the fine iron oxide hydroxide particles. The fine iron oxide hydroxide particles into which aluminum is incorporated, have an aluminum content of usually 0.05 to 50% by weight (calculated as Al) based on the weight of the fine iron oxide hydroxide particles. In the case of the fine oxide hydroxide particles having a composite oxide hydroxide layer containing aluminum and iron on the surface thereof, the composite oxide hydroxide layer has an aluminum content of usually 0.1 to 10% by weight (calculated as Al) based on the weight of the fine iron oxide hydroxide particles, and an iron content of usually 0.1 to 30% by weight (calculated as Fe) based on the weight of the fine iron oxide hydroxide particles.

The fine iron oxide hydroxide particles have an average major axis diameter of usually from 0.005 μm to less than 0.1 μm When the average major axis diameter of the fine iron oxide hydroxide particles is less than 0.005 μm the particles tend to be agglomerated by the increase of intermolecular force therebetween due to fine particles. As a result, it may be difficult to form a uniform coating layer comprising the organosilicon compound on the surface of the fine iron oxide hydroxide particles, and uniformly adhere the organic blue pigments onto the surface of the coating layer. When the average major axis diameter is not less than 0.1 μm, the obtained fine composite pigments also become coarse, resulting in increased hiding power.

In the consideration of the formation of a uniform coating layer comprising the organosilicon compound on the surface of the fine iron oxide hydroxide particle, the uniform adhesion of the organic blue pigments onto the coating layer, and the hiding power of the obtained fine composite pigments not becoming too high, the average major axis diameter of the fine iron oxide hydroxide particles is preferably 0.008 to 0.096 μm, more preferably 0.01 to 0.092 μm.

The average minor axis diameter of the fine iron oxide hydroxide particles is preferably from 0.0025 to less than 0.05 μm, more preferably 0.004 to 0.048 μm, still more preferably 0.005 to 0.046 μm. The aspect ratio (average major axis diameter/average minor axis diameter) of the fine iron oxide hydroxide particles is preferably not more than 20:1, more preferably not more than 15:1, still more preferably not more than 10:1, and the lower limit of the aspect ratio is 2:1. The BET specific surface area of the fine iron oxide hydroxide particles is preferably 50 to 300 m²/g, more preferably 70 to 280 m²/g, still more preferably 80 to 250 m²/g. The geometrical standard deviation value of major axis diameters of the fine iron oxide hydroxide particles is preferably not more than 1.8, more preferably not more than 1.7, and the lower limit of the geometrical standard deviation value is usually 1.01.

When the average minor axis diameter of the fine iron oxide hydroxide particles is less than 0.0025 μm, the particles tend to be agglomerated by the increase of intermolecular force therebetween due to fine particles. As a result, it may be difficult to form a uniform coating layer comprising the organosilicon compound on the surface of the fine iron oxide hydroxide particles, and uniformly adhere the organic blue pigments onto the surface of the coating layer. The fine iron oxide hydroxide particles having an average minor axis diameter of not less than 0.05 μm may be difficult to produce industrially.

When the aspect ratio is more than 20:1, the particles may be entangled with each other. As a result, it may be difficult to form a uniform coating layer comprising the organosilicon compound on the surface of the fine iron oxide hydroxide particles, and uniformly adhere the organic blue pigments onto the coating layer.

When the BET specific surface area value is less than 50 m²/g, the iron oxide hydroxide particles become coarse, so that the obtained composite pigments also become coarse, resulting in increased hiding power. When the BET specific surface area value is more than 300 m²/g, the particles tend to be agglomerated by the increase of intermolecular force therebetween due to fine particles. As a result, it may be difficult to form a uniform coating layer comprising the organosilicon compound on the surface of the fine iron oxide hydroxide particles, and uniformly adhere the organic blue pigments onto the coating layer.

When the geometrical standard deviation value is more than 1.8, the particles may be inhibited from being uniformly dispersed because of existence of coarse particles. As a result, it may be difficult to form a uniform coating layer comprising the organosilicon compound on the surface of the fine iron oxide hydroxide particles, and uniformly adhere the organic blue pigments onto the coating layer. The fine iron oxide hydroxide particles having an geometrical standard deviation value of less than 1.01 may be difficult to produce industrially.

As to the hue of the fine iron oxide hydroxide particles, the L* value thereof is usually 40 to 80; the a* value thereof is usually −57.7 to +57.7 with the proviso that the a* value is not 0; the b* value thereof is usually from more than 0 to +100; and the c* value thereof is usually 50 to 80. When the L*, a*, b* and c* values are respectively out of the above-specified ranges, it may be difficult to obtain the aimed fine composite pigments having a low chroma.

The hiding power of the fine iron oxide hydroxide particles is preferably less than 600 cm²/g, more preferably not more than 500 cm²/g. When the hiding power is as high as not less than 600 cm²/g, the fine composite pigments obtained by using such fine iron oxide hydroxide particles as core particles may also show a too high hiding power.

The fine iron oxide hydroxide particles have a heat resistance of preferably not less than 180° C., more preferably not less than 185° C. In the consideration of good heat resistance of the obtained fine composite pigments, the use of the fine iron oxide hydroxide particles subjected to any of the above heat resistance-imparting treatments is preferred. In the case of the fine iron oxide hydroxide particles whose surface is treated with an aluminum compound, the heat-resisting temperature thereof is about 240° C. In the case of the fine iron oxide hydroxide particles into which aluminum is incorporated, the heat-resisting temperature thereof is about 245° C. In the case of the fine iron oxide hydroxide particles having a composite oxide hydroxide layer containing aluminum and iron on the surface thereof, the heat-resisting temperature thereof is about 250° C.

Next, the coating layer formed on the surface of the iron oxide hydroxide particles as core particles, comprising the organosilicon compound selected from the group consisting of: (1) organosilane compounds obtainable from alkoxysilane compounds, and (2) polysiloxanes such as polysiloxane and modified polysiloxanes, is explained.

The organosilane compounds (1) may be produced from alkoxysilane compounds represented by the formula (I):

R¹ₐSiX₄₋ₐ (I)

wherein R¹ is C₆H₅—, (CH₃)₂CHCH₂— or n-C_{b}H_{2b+1}— (wherein b is an integer from 1 to 18); X is CH₃O— or C₂H₅O—; and a is an integer from 0 to 3.

Specific examples of the alkoxysilane compounds may include methyltriethoxysilane, dimethyldiethoxysilane, phenyltriethoxysilane, diphenyldiethoxysilane, methyltrimethoxysilane, dimethyldimethoxysilane, phenyltrimethoxysilane, diphenyldimethoxysilane, isobutyltrimethoxysilane, decyltrimethoxysilane or the like. Among these alkoxysilane compounds, in view of the desorption percentage and the adhering effect of the organic blue pigments, methyltriethoxysilane, phenyltriethoxysilane, methyltrimethoxysilane, dimethyldimethoxysilane and isobutyltrimethoxysilane are preferred, and methyltriethoxysilane, methyltrimethoxysilane and phenyltriethoxysilane are more preferred.

As the polysiloxanes (2), there may be used those compounds represented by the formula (II):

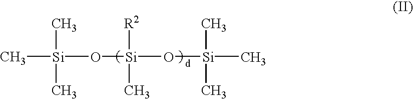

wherein R² is H— or CH₃—, and d is an integer from 15 to 450.

Among these polysiloxanes, in view of the desorption percentage and the adhering effect of the organic blue pigments, polysiloxanes having methyl hydrogen siloxane units are preferred.

As the modified polysiloxanes (2-A), there may be used:

(a) polysiloxanes modified with polyethers represented by the formula (III):

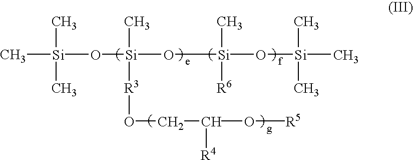

wherein R³ is —(—CH₂—)ₕ—; R⁴ is —(—CH₂—)ᵢ—CH₃; R⁵ is —OH, —COOH, —CH═CH₂, —C(CH₃)═CH₂ or —(—CH₂—)ⱼ—CH₃; R⁶ is —(—CH₂—)ₖ—CH₃; g and h are an integer from 1 to 15; i, j and k are an integer from 0 to 15; e is an integer from 1 to 50; and f is an integer from 1 to 300;

(b) polysiloxanes modified with polyesters represented by the formula (IV):

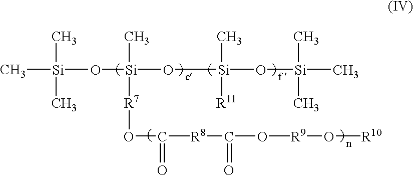

wherein R⁷, R⁸ and R⁹ are —(—CH₂—)_{q}— and may be the same or different; R¹⁰ is —OH, —COOH, —CH═CH₂, —C(CH₃)═CH₂ or —(—CH₂—)ᵣ—CH₃; R¹¹ is —(—CH₂—)ₛ—CH₃; n and q are an integer from 1 to 15; r and s are an integer from 0 to 15; e′ is an integer from 1 to 50; and f′ is an integer from 1 to 300;

(c) polysiloxanes modified with epoxy compounds represented by the formula (V):

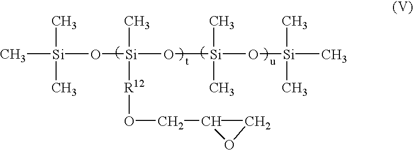

wherein R¹² is —(—CH₂—)ᵥ—; v is an integer from 1 to 15; t is an integer from 1 to 50; and u is an integer from 1 to 300; or a mixture thereof.

Among these modified polysiloxanes (2-A), in view of the desorption percentage and the adhering effect of the organic blue pigments, the polysiloxanes modified with the polyethers represented by the formula (III), are preferred.

As the terminal-modified polysiloxanes (2-B), there may be used those represented by the formula (VI):

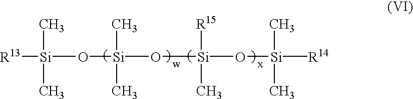

wherein R¹³ and R¹⁴ are —OH, R¹⁶OH or R¹⁷COOH and may be the same or different; R¹⁵ is —CH₃ or —C₆H₅; R¹⁶ and R¹⁷ are —(—CH₂—)_{y}—; y is an integer from 1 to 15; w is an integer from 1 to 200; and x is an integer from 0 to 100.

Among these terminal-modified polysiloxanes, in view of the desorption percentage and the adhering effect of the organic blue pigments, the polysiloxanes whose terminals are modified with carboxylic acid groups are preferred.

The coating amount of the organosilicon compounds is usually 0.02 to 5.0% by weight, preferably 0.03 to 4.0% by weight, more preferably 0.05 to 3.0% by weight (calculated as Si) based on the weight of the core particles coated with the organosilicon compounds.

When the coating amount of the organosilicon compounds is less than 0.02% by weight, it may be difficult to adhere the organic blue pigments in a predetermined amount.

When the coating amount of the organosilicon compounds is more than 5.0% by weight, the organic blue pigments can be adhered in a predetermined amount. Therefore, it is unnecessary and meaningless to coat the core particles with such a large amount of the organosilicon compounds.

As the organic blue pigments used in the present invention, there may be used phthalocyanine-based pigments such as metal-free phthalocyanine blue and phthalocyanine blue (copper phthalocyanine), alkali blue or the like.

The amount of the organic blue pigment adhered is usually 1 to 20 parts by weight, preferably 1.5 to 15 parts by weight, more preferably 2.0 to 10 parts by weight based on 100 parts by weight of the iron oxide hydroxide particles.

When the amount of the organic blue pigments adhered is less than 1 part by weight or more than 20 parts by weight, it may be difficult to obtain fine composite pigments having a low chroma.

The particle shape and particle size of the fine composite pigments of the present invention considerably depends on those of the fine iron oxide hydroxide particles used as core particles. As a result, the fine composite pigments have a similar particle configuration to that of the core particles.

Namely, the fine composite pigments of the present invention have an average major axis diameter of usually from 0.005 to less than 0.1 μm, preferably 0.008 to 0.096 μm, more preferably 0.01 to 0.092 μm.

When the average major axis diameter of the fine composite pigments is not less than 0.1 μm, the pigments become coarse, resulting in increased hiding power. As a result, a film obtained using such composite pigments fails to show a sufficient transparency, or in case of a colored film, the coloring property (coloring effect) of the colorant contained in the colored film may be deteriorated. When the average major axis diameter of the fine composite pigments is less than 0.005 μm, the pigments tend to be agglomerated by the increase of intermolecular force therebetween due to fine particles. As a result, it may be difficult to disperse the composite pigments in thermoplastic resins.

The particle shape of the fine composite pigments may be an acicular shape and a rectangular shape.

The average minor axis diameter of the fine composite pigments is preferably from 0.0025 to less than 0.05 μm, more preferably 0.004 to 0.048 μm, still more preferably 0.005 to 0.046 μm. When the average minor axis diameter of the fine composite pigments is less than 0.0025 μm, the pigments tend to be agglomerated by the increase of intermolecular force therebetween due to fine particles. As a result, it may be difficult to disperse the fine composite pigments in thermoplastic resins. The fine composite pigments having an average minor axis diameter of not less than 0.05 μm may be difficult to produce industrially.

The aspect ratio of the fine composite pigments is preferably not more than 20:1, more preferably 2:1 to 15:1, still more preferably 2:1 to 10:1. When the aspect ratio is more than 20:1, the pigments may be entangled with each other. As a result, it may be difficult to disperse the fine composite pigments in thermoplastic resins.

The BET specific surface area of the fine composite pigments is preferably 50 to 300 m²/g, more preferably 70 to 280 m²/g, still more preferably 80 to 250 m²/g. When the BET specific surface area value is less than 50 m²/g, the obtained composite pigments become coarse, resulting in increased hiding power. As a result, a film obtained using such composite pigments fails to show a sufficient transparency, or in case of a colored film, the coloring property (coloring effect) of the colorant contained in the colored film may be deteriorated. When the BET specific surface area value is more than 300 m²/g, the pigments tend to be agglomerated by the increase of intermolecular force therebetween due to fine particles. As a result, it may be difficult to disperse the fine composite pigments in thermoplastic resins.

The geometrical standard deviation value of particle diameters of the fine composite pigments is preferably not more than 1.8. When the geometrical standard deviation value is more than 1.8, the pigments may be inhibited from being uniformly dispersed in thermoplastic resins because of existence of coarse particles. In the consideration of uniform dispersion in thermoplastic resins, the geometrical standard deviation value is preferably not more than 1.7. The lower limit of the geometrical standard deviation value is 1.01. The fine composite pigments having an geometrical standard deviation value of less than 1.01 may be difficult to produce industrially.

The fine composite pigments have a desorption percentage of organic blue pigments of preferably not more than 15%, more preferably not more than 12%. When the desorption percentage of organic blue pigments is more than 15%, the fine composite pigments may be prevented from being uniformly dispersed in thermoplastic resins because of a large amount of the organic blue pigments desorbed therefrom.

As to the hue of the fine composite pigments, the L* value thereof is usually 25 to 80; the a* value thereof is usually −20 to +20, preferably −18 to +15, more preferably −16 to +10; the b* value thereof is usually −20 to +20, preferably −18 to +18, more preferably −16 to +16; and the c* value thereof is usually 0 to 20, preferably 0 to 18, more preferably 0 to 16.

The fine composite pigments of the present invention can exhibit an improved heat resistance by coating the surface of the fine iron oxide hydroxide particles inherently having a poor heat resistance with the organosilane compounds or polysiloxanes having an excellent heat resistance, and further fixing the organic blue pigments having an excellent heat resistance on the obtained coating layer.

The heat resisting temperature of the fine composite pigments is higher by usually about +5 to +40° C. than that of the fine iron oxide hydroxide particles as core particles. Namely, the fine composite pigments can exhibit a heat-resisting temperature of preferably not less than 210° C., more preferably not less than 215° C.

The hiding power of the fine composite pigments is preferably less than 600 cm²/g, more preferably not more than 500 cm²/g. When the hiding power is as high as not less than 600 cm²/g, a film obtained using such fine composite pigments fails to show a sufficient transparency, or in case of a colored film, the coloring property (coloring effect) of the colorant contained in the colored film may be deteriorated.

Also, the fine composite pigments of the present invention contain no harmful elements such as Cr, Pb and Cd and, therefore, are not only excellent in hygiene and safety, but also free from environmental pollution.

Upon the production of the fine composite pigments, the fine iron oxide hydroxide particles may be preliminarily coated with at least one material selected from the group consisting of hydroxides of aluminum, oxides of aluminum, hydroxides of silicon and oxides of silicon (hereinafter referred to merely as “hydroxides and/or oxides of aluminum and/or silicon”), if necessary. In the case of the fine iron oxide hydroxide particles coated with hydroxides and/or oxides of aluminum and/or silicon, the organic blue pigments adhered can be more effectively prevented from being desorbed therefrom as compared to uncoated particles. Further, such coated particles can be slightly improved in heat resistance.

The amount of the hydroxides and/or oxides of aluminum and/or silicon coated is preferably 0.01 to 20% by weight (calculated as Al, SiO₂ or sum of Al and SiO₂) based on the weight of the fine iron oxide hydroxide particles coated with the hydroxides and/or oxides of aluminum and/or silicon.

When the amount of the hydroxides and/or oxides of aluminum and/or silicon coated is less than 0.01% by weight, it may be difficult to obtain the effect of reducing the desorption percentage of the organic blue pigments. When the amount of the hydroxides and/or oxides of aluminum and/or silicon coated lies within the range of 0.01 to 20% by weight, a sufficient effect of reducing the desorption percentage of the organic blue pigments can be attained. Therefore, the use of the coating amount of more than 20% by weight is unnecessary and meaningless.

The particle size, geometrical standard deviation value, BET specific surface area value, hue and hiding power of the fine composite pigments coated with the hydroxides and/or oxides of aluminum and/or silicon, are substantially the same as those of the fine composite pigments uncoated therewith. The desorption percentage of the organic blue pigments from the fine composite pigments can be reduced by forming the coating layer composed of hydroxides and/or oxides of aluminum and/or silicon thereon, and is preferably not more than 12%, more preferably not more than 10%. Further, the heat resistance of the fine composite pigments using the core particles subjected to the above heat-resistance-imparting treatment can be enhanced by about +5 to +30° C. as compared to the fine composite pigments using untreated core particles.

Next, the process for producing the fine composite particles according to the present invention, is described.

The fine composite particles of the present invention can be produced by mixing iron oxide hydroxide particles as core particles with alkoxysilane compounds or polysiloxanes such as polysiloxanes, modified polysiloxanes or terminal-modified polysiloxanes to coat the surfaces of the core particles with the alkoxysilane compounds or the polysiloxanes; and then mixing the core particles coated with the alkoxysilane compounds or the polysiloxanes, with an organic blue pigment.

The coating of the iron oxide hydroxide particles as core particles with the alkoxysilane compounds, the polysiloxanes, the modified polysiloxanes, or the terminal-modified polysiloxanes, may be conducted (i) by mechanically mixing and stirring the iron oxide hydroxide particles together with the alkoxysilane compounds, the polysiloxanes, the modified polysiloxanes, or the terminal-modified polysiloxanes; or (ii) by mechanically mixing and stirring both the components together while spraying the alkoxysilane compounds, the polysiloxanes, the modified polysiloxanes, or the terminal-modified polysiloxanes onto the iron oxide hydroxide particles. In these cases, substantially whole amount of the alkoxysilane compounds, the polysiloxanes, the modified polysiloxanes, or the terminal-modified polysiloxanes added can be applied onto the surfaces of the iron oxide hydroxide particles.

In addition, by conducting the above-mentioned mixing or stirring treatment (1) of the iron oxide hydroxide particles as iron oxide hydroxide particles together with the alkoxysilane compounds, at least a part of the alkoxysilane compounds coated on the iron oxide hydroxide particles may be changed to the organosilane compounds. In this case, there is also no affection against the formation of the organic blue pigment coat thereon.

As apparatus (a) for mixing and stirring treatment (i) of the iron oxide hydroxide particles with the alkoxysilane compounds, the polysiloxanes, the modified polysiloxanes, or the terminal-modified polysiloxanes to form the coating layer thereof, and as apparatus (b) for mixing and stirring treatment (ii) of the organic blue pigment with the core particles whose surfaces are coated with the alkoxysilane compounds, the polysiloxanes, the modified polysiloxanes, or the terminal-modified polysiloxanes to form the organic blue pigment coat, there may be preferably used those apparatus capable of applying a shear force to the particles, more preferably those apparatuses capable of conducting the application of shear force, spaturate force and compressed force at the same time. As such apparatuses, there may be exemplified wheel-type kneaders, ball-type kneaders, blade-type kneaders, roll-type kneaders or the like. Among them, wheel-type kneaders are preferred. Specific examples of the wheel-type kneaders may include an edge runner (equal to a mix muller, a Simpson mill or a sand mill), a multi-mull, a Stotz mill, a wet pan mill, a Conner mill, a ring muller, or the like. Among them, an edge runner, a multi-mull, a Stotz mill, a wet pan mill and a ring muller are preferred, and an edge runner is more preferred.

Specific examples of the ball-type kneaders may include a vibrating mill or the like. Specific examples of the blade-type kneaders may include a Henschel mixer, a planetary mixer, a Nawter mixer or the like. Specific examples of the roll-type kneaders may include an extruder or the like.

In order to coat the surfaces of the iron oxide hydroxide particles with the alkoxysilane compounds, the polysiloxanes, the modified polysiloxanes, or the terminal-modified polysiloxanes as uniformly as possible, the conditions of the above mixing or stirring treatment may be appropriately controlled such that the linear load is usually 19.6 to 1960 N/cm (2 to 200 Kg/cm), preferably 98 to 1470 N/cm (10 to 150 Kg/cm), more preferably 147 to 980 N/cm (15 to 100 Kg/cm); and the treating time is usually 5 to 120 minutes, preferably 10 to 90 minutes. It is preferred to appropriately adjust the stirring speed in the range of usually 2 to 2,000 rpm, preferably 5 to 1,000 rpm, more preferably 10 to 800 rpm.

The amount of the alkoxysilane compounds, the polysiloxanes, the modified polysiloxanes, or the terminal-modified polysiloxanes added, is preferably 0.15 to 45 parts by weight based on 100 parts by weight of the iron oxide hydroxide particles as core particles. When the amount of the alkoxysilane compounds, the polysiloxanes, the modified polysiloxanes or the terminal-modified polysiloxanes added is less than 0.15 part by weight, it may become difficult to adhere the organic blue pigment in such an amount enough to obtain the fine composite pigments used in the present invention. On the other hand, when the amount of the alkoxysilane compounds, the polysiloxanes, the modified polysiloxanes or the terminal-modified polysiloxanes added is more than 45 parts by weight, since a sufficient amount of the organic blue pigment can be adhered on the surface of the coating layer, it is meaningless to add more than 45 parts by weight.

Next, the organic blue pigment are added to the iron oxide hydroxide particles as core particles, which are coated with the alkoxysilane compounds, the polysiloxanes, the modified polysiloxanes, or the terminal-modified polysiloxanes, and the resultant mixture is mixed and stirred to form the organic blue pigment coat on the surfaces of the coating layer composed of the alkoxysilane compounds, the polysiloxanes, the modified polysiloxanes or the terminal-modified polysiloxanes. The drying or heat-treatment may be conducted.

It is preferred that the organic blue pigment are added little by little and slowly, especially about 5 to 60 minutes.

In order to form organic blue pigment coat onto the coating layer composed of the alkoxysilane compounds, the polysiloxanes, the modified polysiloxanes, or the terminal-modified polysiloxanes as uniformly as possible, the conditions of the above mixing or stirring treatment can be appropriately controlled such that the linear load is usually 19.6 to 1960 N/cm (2 to 200 Kg/cm), preferably 98 to 1470 N/cm (10 to 150 Kg/cm), more preferably 147 to 980 N/cm (15 to 100 Kg/cm); and the treating time is usually 5 to 120 minutes, preferably 10 to 90 minutes. It is preferred to appropriately adjust the stirring speed in the range of usually 2 to 2,000 rpm, preferably 5 to 1,000 rpm, more preferably 10 to 800 rpm.

The preferable amount of the organic blue pigment added is 1 to 20 parts by weight based on 100 parts by weight of the iron oxide hydroxide particles. When the amount of the organic blue pigment added is out of the above-mentioned range, it may be difficult to obtain fine composite pigments exhibiting a low chroma.

In case of drying the obtained fine composite pigments, the temperature is usually 40 to 150° C., preferably 60 to 120° C. The treating time of these steps is usually from 10 minutes to 12 hours, preferably from 30 minutes to 3 hours.

When the obtained fine composite pigments is subjected to the above step, the alkoxysilane compounds used as the coating thereof are finally converted into organosilane compounds.

If required, prior to mixing and stirring with the alkoxysilane compounds or polysiloxanes, least a part of the surface of the iron oxide hydroxide particles may be preliminarily coated with at least one compound selected from the group consisting of hydroxides of aluminum, oxides of aluminum, hydroxides of silicon and oxides of silicon (hereinafter referred to merely as “hydroxides and/or oxides of aluminum and/or silicon”), in advance of mixing and stirring with the alkoxysilane compounds, the polysiloxanes, the modified polysiloxanes or the terminal-modified polysiloxanes.

The coating of the hydroxides and/or oxides of aluminum and/or silicon may be conducted by adding an aluminum compound, a silicon compound or both the compounds to a water suspension in which the iron oxide hydroxide particles are dispersed, followed by mixing and stirring, and further adjusting the pH value of the suspension, if required, thereby coating the surfaces of the iron oxide hydroxide particles with hydroxides and/or oxides of aluminum and/or silicon. The thus obtained iron oxide hydroxide particles coated with the hydroxides and/or oxides of aluminum and/or silicon are then filtered out, washed with water, dried and pulverized. Further, iron oxide hydroxide particles coated with the hydroxides and/or oxides of aluminum and/or silicon may be subjected to post-treatments such as deaeration treatment and compaction treatment, if required.

As the aluminum compounds, there may be exemplified aluminum salts such as aluminum acetate, aluminum sulfate, aluminum chloride or aluminum nitrate, alkali aluminates such as sodium aluminate or the like.

The amount of the aluminum compound added is 0.01 to 20% by weight (calculated as Al) based on the weight of the iron oxide hydroxide particles.

As the silicon compounds, there may be exemplified #3 water glass, sodium orthosilicate, sodium metasilicate or the like.

The amount of the silicon compound added is 0.01 to 20% by weight (calculated as SiO₂) based on the weight of the iron oxide hydroxide particles.

The plastic film of the present invention can be produced by molding a thermoplastic resin containing the above fine composite pigments in an amount of usually 0.01 to 2.0% by weight, preferably 0.015 to 1.5% by weight, more preferably 0.02 to 1.0% by weight, into a film.

When the content of the fine composite pigments is less than 0.01% by weight, the obtained plastic film is deteriorated in complete combustion percentage showing the amount of cinders or residual ashes after incineration, or low-temperature combustibility showing a temperature required for completely burning organic substances contained therein, resulting in poor combustion efficiency. When the content of the fine composite pigments is more than 2% by weight, the obtained plastic film tends to be deteriorated in transparency, or in case of a colored film, the coloring property (coloring effect) of the colorant contained in the colored film may be deteriorated.

As the thermoplastic resin used in the present invention, there may be exemplified polyolefin-based resins such as low- and high-density polyethylene resins, polypropylene resins and ethylene-vinyl acetate copolymer resins; polyamide resins such as nylon 6 and nylon 66; or the like. Among these thermoplastic resins, polyethylene resins and polypropylene resins are preferred.

The plastic film of the present invention may also contain a colorant in an amount of usually 0.01 to 2.0% by weight based on the weight of the thermoplastic resin. That is, the plastic film of the present invention is produced by molding a thermoplastic resin composition containing 0.01 to 2.0% by weight of the colorant and 0.01 to 2.0% by weight of the fine composite pigments based on the weight of the thermoplastic resin, into a film shape.

As the colorant used in the present invention, there may be exemplified organic pigments, inorganic pigments and dyes. Specific examples of the organic pigments may include phthalocyanine-based pigments such as phthalocyanine blue and phthalocyanine green; condensed polycyclic pigments such as quinacridone-based pigments; azo pigments such as disazo yellow; or the like. Specific examples of the inorganic pigments may include titanium oxide, carbon black, iron oxides such as hematite, magnetite and maghemite, or the like. Specific examples of the dyes may include dyeing lake pigments prepared by insolubilizing dyes, or the like. Among these colorants, organic and inorganic pigments are preferred.

In particular, as the colorants contained in plastic films for production of shopping bags, packages of foods, etc., the use of organic or inorganic pigments containing no harmful elements such as Cr, Pb and Cd, is preferred.

The content of the colorant in the plastic film is usually 0.01 to 2.0% by weight, preferably 0.015 to 1.9% by weight, more preferably 0.02 to 1.8% by weight based on the weight of the thermoplastic resin. When the colorant content is less than 0.01% by weight, it may be difficult to obtain a plastic film having a clear hue, because of a too small amount of the colorant added. When the colorant content is more than 2.0% by weight, although it is possible to obtain a plastic film having a clear hue, the coloring effect of the colorant is already saturated and, therefore, the use of such a large amount of the colorant is unnecessary and meaningless.

The plastic film of the present invention preferably has a thickness of not less than 5 μm in the consideration of processability thereof. The upper limit of the thickness of the plastic film is 300 μm. When the thickness of the plastic film is more than 300 μm, the obtained plastic film tends to be deteriorated in processability. In the consideration of processability, the thickness of the plastic film is more preferably 10 to 100 μm.

In case of no colorant added, as to the transparency of the plastic film of the present invention, the linear absorption thereof at a wavelength of 600 nm is preferably not more than 0.050 μm⁻¹, more preferably not more than 0.030 μm⁻¹.

As to the chroma of the plastic film of the present invention, the C* value thereof is preferably 0 to 18, more preferably 0 to 16, most preferably 0 to 14.

As to the coloring property (coloring effect) of the colorant contained in the plastic film of the present invention, the ΔE* value thereof is preferably not more than 10, more preferably not more than 8 when evaluated by the below-mentioned method. The colorant contained in the plastic film can exhibit the substantially same clear hue as that of the colorant only.

The combustion velocity of the plastic film of the present invention is preferably not more than 2.5 minutes, more preferably not more than 2.0 minutes as measured in air by the below-mentioned method.

The complete combustion percentage of the plastic film of the present invention is preferably not less than 90% by weight, more preferably not less than 94% by weight as measured in air by the below-mentioned method.

The low-temperature combustibility of the plastic film of the present invention is preferably not more than 510° C., more preferably not more than 490° C. as measured in air by the below-mentioned method.

Next, the process for producing the plastic film of the present invention is described.

The plastic film of the present invention can be produced by following method. That is, the thermoplastic resins such as polyethylene resins are mixed with the fine composite pigments. The resultant composition is fed to an ordinary extruder or the like, melt-kneaded therein, and then formed into a film having a thickness of about 5 to 300 μm by an inflation method, a T-die method or the like. In case of a plastic bag, the thus obtained film is heat-sealed to form a plastic bag having a desired size.

The plastic resin film used for the production of plastic bags according to the present invention may contain in addition to the fine composite pigments or the fine composite pigments and colorants, various known additives such as lubricants, anti-blocking agents, antioxidants, weather-resisting agents and the like as well as various organic or inorganic fillers, if required.

In particular, the plastic film is preferably produced by the following method. That is, the below-mentioned master batch pellets for plastic film are mixed with a diluting binder resin such as polyethylene-based resin or the like, by a ribbon blender, a Nawter mixer, a Henschel mixer, a Super mixer or the like. The resultant mixture is melt-kneaded, and then formed into a film having a thickness of about 5 to about 300 μm by an inflation method, a T-die method or the like.

The master batch pellets and the diluting binder resin may be respectively supplied to the kneader from separate sources at a predetermined quantitative ratio, or may be supplied in the form of a mixture thereof to the kneader.

Examples of the polyolefin-based resin used in the present invention may include branched low-density, or linear low-density or high-density polyethylene resins, polypropylene resins, copolymer resins of ethylene with methacrylic acid esters or other polymerizable monomers such as vinyl acetate, or the like. Among these polyolefin-based resins, polyethylene resins and polypropylene resins are preferred.

Upon the production of the plastic film of the present invention, in addition to the fine composite pigments, various known additives such as lubricants, anti-blocking agents, antioxidants and weather-resisting agents as well as various organic and inorganic fillers may be appropriately blended therein.

The master batch pellets and the diluting binder resin may be blended with each other in such an amount that the content of the fine composite pigments in the plastic film is usually 0.01 to 2.0% by weight, preferably 0.015 to 1.5% by weight, more preferably 0.02 to 1.0% by weight based on the total weight of the polyolefin-based resins. In addition, the amount of the master batch pellets blended is usually 0.1 to 13.0 parts by weight based on 100 parts by weight of the diluting binder resin.

When the content of the fine composite pigments is less than 0.01% by weight, the obtained plastic film tends to be deteriorated in complete combustion percentage representing the amount of cinders or residual ashes after incineration, and low-temperature combustibility representing the temperature required for completely burning organic substances contained therein, thereby failing to attain a more excellent combustion efficiency. When the content of the fine composite pigments is more than 2.0% by weight, the obtained plastic film tends to be deteriorated in transparency, or in case of a colored film, the coloring property (coloring effect) of the colorant contained in the colored film may be deteriorated.

Next, the master batch pellets used in the production process of the plastic film according to the present invention, are described.

The master batch pellets for plastic film according to the present invention may be produced by the following method. That is, the polyolefin-based resin as a binder resin is mixed with the fine composite pigments, if required, using a mixing device such as a ribbon blender, a Nawter mixer, a Henschel mixer and a Super mixer. Then, the resultant mixture is kneaded and molded using a known single- or twin-screw kneading extruder, and then the extruded product is cut into pellets. Alternatively, the mixture is kneaded by a Banbury mixer, a pressure kneader or the like, and then the obtained kneaded material is pulverized, or molded and cut into pellets.

The binder resin and the fine composite pigments may be respectively supplied to the kneader from separate sources at a predetermined quantitative ratio, or may be supplied in the form of a mixture thereof to the kneader.

The master batch pellets for plastic film according to the present invention have an average major axis diameter of usually 1 to 6 mm, preferably 2 to 5 mm; and an average minor axis diameter of usually 2 to 5 mm, preferably 2.5 to 4 mm. When the average major axis diameter is less than 1 mm, the workability upon production of the pellets tends to be deteriorated. When the average major axis diameter is more than 6 mm, the size of the obtained master batch pellets is considerably different from that of the diluting binder resin, so that it may be difficult to sufficiently disperse the pellets in the diluting binder resin. The shape of the master batch pellets may include a granular shape such as an amorphous shape and a spherical shape, a cylindrical shape, a flake-like shape or the like.

The binder resin used in the master batch pellets for plastic film according to the present invention may be the same as the diluting binder resin.

Meanwhile, the binder resin contained in the master batch pellets may be either the same as the diluting binder resin, or a different kind of resin. When the different kind of resin is used as the binder resin for the master batch pellets, the binder resin and the diluting binder resin may be selected so as to have a good compatibility therebetween.

The amount of the fine composite pigments blended in the master batch pellets is usually 1 to 43 parts by weight, preferably 5 to 25 parts by weight based on 100 parts by weight of the binder resin.

When the amount of the fine composite pigments blended is less than 1 part by weight, it may be difficult to sufficiently disperse and mix the composite pigments in the binder resin because of poor melt viscosity upon the kneading. When the amount of the fine composite pigments blended is more than 43 parts by weight, it may also be difficult to sufficiently disperse and mix the composite pigments in the binder resin because of lack of the binder resin. Further, since the content of the fine composite pigments in the plastic film is considerably varied even by slight change in amount of the master batch pellets added, it may be difficult to control the content of the fine composite pigments in the plastic film to the aimed value. In addition, mechanical parts used upon the kneading may be severely abraded or damaged.

The point of the present invention is that the plastic film produced from the thermoplastic resin containing the fine composite pigments which comprise fine iron oxide hydroxide particles, a coating layer formed on the surface of the fine iron oxide hydroxide particle, comprising organosilane compounds or polysiloxanes, and an organic blue pigment coat formed on the coating layer, in an amount of 0.01 to 2% by weight, can exhibit not only an excellent color, but also an excellent combustion efficiency upon incineration for disposal.

The reason why the colorant contained in the plastic film of the present invention can show a good coloring effect without deterioration, is considered by the present inventors as follows. That is, it is considered that the inherent hue of the colorant can be exhibited without adverse influence of the fine composite pigments, since not only the colorant but also the fine composite pigments have a low hiding power and a low chroma.

The reason why the plastic film of the present invention can exhibit a more excellent combustion efficiency, is considered as follows. That is, although the conventional fine iron oxide hydroxide particles are unsuitable for the production of plastic films because of poor dispersibility therein, the composite pigments obtained by adhering the organic blue pigments onto the fine iron oxide hydroxide particles according to the present invention can be considerably improved in dispersibility and, therefore, can exhibit a sufficient oxidation activity inherent thereto upon combustion of the plastic film.

Thus, the plastic film of the present invention has an excellent color, but also a more excellent combustion efficiency upon disposal, by incorporating the fine composite pigments having an improved heat resistance thereinto. Therefore, the plastic film can be suitably used for shopping bags, garbage bags or the like.

The shopping bag or the garbage bag of the present invention can show a well-controlled transparency and color by adequately selecting the particle size and content of ferric oxide hydroxide particles.

Further, the shopping bag or the garbage bag of the present invention can exhibit a more excellent combustion efficiency upon disposal after use despite a small content of the ferric oxide hydroxide particles acting as a combustion promoter. Namely, since the fine composite pigments contained in the plastic film are much finer, when the plastic film is burned together with combustible wastes in an incinerator, the combustion thereof can be more effectively accelerated. As a result, even though the incinerator is operated under low-temperature and low-oxygen concentration conditions for reducing the amount of NOx generated and avoiding breakage of the incinerator, the combustible wastes can be burned at a higher combustion efficiency, resulting in a less amount of cinders and residual ashes produced therein.

Moreover, since the inherent catalytic combustion effect of the ferric iron oxide hydroxide particles can be further accelerated, it can be expected to more effectively reduce the amount of NOx produced, and avoid the production of dioxin due to complete combustion of combustible wastes.

In addition, the plastic film containing the colorant according to the present invention can exhibit not only the inherent hue of the colorant but also a more excellent combustion efficiency upon disposal treatment. Therefore, the plastic film of the present invention can be suitably used for shopping bags, garbage bags or the like.

Thus, in accordance with the present invention, since the master batch pellets comprising the fine composite pigments having a low hiding power, a low chroma and an enhanced heat resistance, are kneaded with the polyolefin-based resin, the fine composite pigments can be enhanced in dispersibility in the polyolefin-based resin. As a result, it becomes possible to produce the plastic film not only having a more excellent color but also showing a more excellent combustion efficiency upon disposal treatment, in an industrially and economically useful manner.

Also, the shopping bags and garbage bags produced from the plastic film obtained by using the master batch pellets by the above method, can exhibit well-controlled color by adequately selecting the particle size and content of the ferric oxide hydroxide particles used therein.

Further, the shopping bags and garbage bags produced from the plastic film obtained by using the master batch pellets by the above method, can exhibit a more excellent combustion efficiency upon disposal treatment after use, despite a very small content of the iron oxide hydroxide particles used as a combustion accelerator. Namely, since the composite pigments contained in the plastic film are much finer particles and the master batch pellets comprising such fine composite pigments are kneaded with the polyolefin-based resin, the dispersibility of the fine composite pigments in the polyolefin-based resin can be considerably improved. As a result, when the obtained shopping bags and garbage bags are burned together with combustible wastes in an incinerator, the combustion accelerating effect of the fine composite pigments can be further promoted. In addition, even when the incinerator is operated under low-temperature and low-oxygen concentration conditions which are conventionally considered to be useful for reducing the amount of NOx produced and inhibiting damage to the incinerator, the combustible wastes together with the shopping bags and garbage bags can be burned at a high efficiency, resulting in a less amount of cinders and residual ashes.

### EXAMPLES

The present invention is described in more detail by Examples and Comparative Examples, but the Examples are only illustrative and, therefore, not intended to limit the scope of the present invention.

Various properties were evaluated by the following methods.

(1) The average major axis diameter and average minor axis diameter of iron oxide hydroxide particles, organic blue pigment and fine composite pigments were respectively expressed by average values (measured in a predetermined direction) of about 350 particles which were sampled from a micrograph obtained by magnifying an original electron micrograph (×30,000) by four times in each of the longitudinal and transverse directions.

(2) The aspect ratio of the particles was expressed by a ratio of average major axis diameter to minor axis diameter thereof.

(3) The geometrical standard deviation of the major axis diameters of the particles was expressed by values obtained by the following method. That is, the major axis diameters of the particles were measured from the above-magnified photograph. The actual major axis diameters and the number of the particles were obtained from the calculation on the basis of the measured values. On a logarithmic normal probability paper, the major axis diameters of the particles were plotted at regular intervals on the abscissa-axis and the accumulative number of particles belonging to each interval of the major axis diameters of the particles were plotted by percentage on the ordinate-axis by a statistical technique. The major axis diameters of the particles corresponding to the number of particles of 50% and 84.13%, respectively, were read from the graph, and the geometrical standard deviation was measured from the following formula:

Geometrical standard deviation={major axis diameter of the particle corresponding to 84.13% under integration sieve}/{major axis diameter of the particle (geometrical average diameter) corresponding to 50% under integration sieve}

The more the geometrical standard deviation coser to 1.0, the more excellent the major axis diameter distribution of the particles.

(4) The specific surface area was expressed by values measured by a BET method.

(5) The amounts of Al and Si which were present within iron oxide hydroxide particles or on the surfaces thereof, the amount of Si contained in organosilicon compounds, were measured by a fluorescent X-ray spectroscopy device 3063M (manufactured by RIGAKU DENKI KOGYO CO., LTD.) according to JIS K0119 “General rule of fluorescent X-ray analysis”.

Meanwhile, the amount of Si contained in oxides of silicon, hydroxides of silicon and organosilicon compounds coated on the surfaces of the iron oxide hydroxide particles or the fine composite pigments, is expressed by the value obtained by subtracting the amount of Si measured prior to the respective treatment steps from that measured after the respective treatment steps.

(6) The average major axis diameter and the average minor axis diameter (average diameter) of the master batch pellets were respectively expressed by average of the values obtained by measuring those dimensions of 10 pellets by calipers.

(7) The amount of Fe contained in the composite oxide hydroxide layer containing aluminum and iron which was coated onto the surface of the fine iron oxide hydroxide particles, was calculated from the weight ratio of Al to Fe obtained based on amounts of Al and Fe contained in the filtrate which were measured by the following method, and the weight percent of Al contained in the composite oxide hydroxide layer which was measured by the above fluorescent X-ray analysis, according to the following formula:

Fe (wt. %)=(weight percent of Al)/(weight ratio of Al to Fe)

That is, 0.25 g of fine iron oxide hydroxide particles were weighed and charged into a 100-ml conical flask. After adding 33.3 ml of ion-exchanged water to the flask, the flask was placed in a water bath heated to 60° C., and the contents of the flask were stirred and dispersed for 20 minutes using a magnetic stirrer, thereby obtaining a suspension. Then, 16.7 ml of a 12N hydrochloric acid solution was added to the obtained suspension, and the suspension was further stirred for 20 minutes, thereby dissolving a portion of the composite oxide hydroxide layer containing aluminum and iron which was coated onto the surface of the fine iron oxide hydroxide particles, in the acid. More specifically, the portion of the composite oxide hydroxide layer dissolved in the acid was such a portion having a substantially uniform composition, and extending inwardly from the outermost surface of the composite iron oxide hydroxide layer up to a mid portion of the distance between the outermost surface of the composite iron oxide layer and the surface of each fine iron oxide hydroxide particle (this fact has been recognized from the results of many experiments). The suspension obtained by the acid-dissolution was subjected to suction filtration using a 0.1 μm membrane filter. The amounts (ppm) of Al and Fe contained in the obtained filtrate were respectively measured using an inductively coupled plasma atomic emission spectrometer (“SPS4000”, manufactured by Seiko Denshi Kogyo Co., Ltd.).

(8) The amount of organic blue pigments adhered onto the surface of the fine iron oxide hydroxide particles was measured by “Horiba Metal, Carbon and Sulfur Analyzer EMIA-2200 Model” (manufactured by Horiba Seisakusho Co., Ltd.).

(9) The desorption percentage (%) of organic blue pigment desorbed from the fine composite pigments was measured by the following method.

That is, 3 g of the fine composite particles and 40 ml of ethanol were placed in a 50-ml precipitation pipe and then was subjected to ultrasonic dispersion for 20 minutes. Thereafter, the obtained dispersion was allowed to stand for 120 minutes, and separated the organic blue pigment desorbed from the fine composite particles on the basis of the difference in specific gravity therebetween. Next, the thus separated fine composite pigments were mixed again with 40 ml of ethanol, and the obtained mixture was further subjected to ultrasonic dispersion for 20 minutes. Thereafter, the obtained dispersion was allowed to stand for 120 minutes, thereby separating the fine composite pigments and organic blue pigment desorbed, from each other. The thus separated fine composite pigments were dried at 80° C. for one hour, and then the residual amount of the organic blue pigment was measured by the “Horiba Metal, Carbon and Sulfur Analyzer EMIA-2200 Model” (manufactured by HORIBA SEISAKUSHO CO., LTD.). The desorption percentage (%) was calculated according to the following formula:

Desorption percentage (%)={(Wₐ−Wₑ)/Wₐ}×100

wherein Wₐ represents an amount of organic blue pigment initially adhered on the fine composite pigments; and Wₑ represents an amount of organic blue pigment which still remains on the fine composite pigments after the above desorption test.

The closer to zero the desorption percentage (%), the smaller the amount of organic blue pigment desorbed from the fine composite pigments.

(10) The hue of each of the fine iron oxide hydroxide particles, the organic blue pigments and the fine composite pigments, was measured by the following method.

That is, 0.5 g of each sample and 0.5 ml of castor oil were intimately kneaded together by a Hoover's muller to form a paste. 4.5 g of clear lacquer was added to the obtained paste and was intimately kneaded together to form a paint. The obtained paint was applied on a cast-coated paper by using a 150 μm (6-mil) applicator to produce a coating film piece (having a film thickness of about 30 μm). The thus obtained coating film piece was measured using a Multi-spectro-colour-Meter “MSC-IS-2D” (manufactured by Suga Shikenki Co., Ltd.) according to JIS Z 8729.

(11) The heat resistance of each of the fine iron oxide hydroxide particles, the organic blue pigments and the fine composite pigments, was respectively expressed by the temperature corresponding to a crossing point of two tangential lines drawn on two curves constituting the first one of two inflection points which form a peak on a DSC chart obtained by subjecting particles to be measured to differential scanning calorimetry (DSC) using a thermal analyzing apparatus SSC5000 (manufactured by Seiko Denshi Kogyo Co., Ltd.).

(12) The hiding power of each of the fine iron oxide hydroxide particles, the organic blue pigments and the fine composite pigments was measured by the cryptometer method according to JIS K 5101-8.2 using the following primary color enamel.

Preparation of Primary Color Enamel:

10 g of the above sample particles, 16 g of an amino alkyd resin and 6 g of a thinner were blended together. The resultant mixture was charged together with 90 g of 3 mmφ glass beads into a 140-ml glass bottle, and then mixed and dispersed for 45 minutes by a paint shaker. The obtained mixture was mixed with additional 50 g of an amino alkyd resin, and further dispersed for 5 minutes by a paint shaker, thereby preparing a primary color enamel.

(13) The hue of a film obtained using the fine composite pigments was determined as follows. That is, a thermoplastic resin and the fine composite pigments were melt-kneaded together. The resultant kneaded material was formed into a film having a thickness of 30 μm by an inflation method. The thus obtained film was placed on a standard white plate, and the hue thereof was measured using a Multi-spectro-colour-Meter “MSC-IS-2D” (manufactured by SUGA SHIKENKI CO., LTD.) according to JIS Z 8729.

(14) The coloring effect of the colorant contained in the plastic film was determined by the following method. That is, the hues of the colored plastic film of the present invention and a comparative colored plastic film having the same composition as that of the former plastic film except for incorporating no fine composite pigments thereinto, were measured by the same method as described above. The coloring effect was expressed by the AE* value calculated from the measured L*, a* and b* values according to the following formula:

ΔE*value=[(ΔL*)²+(Δa*)²+(Δb*)²]^{1/2}

wherein ΔL* represents the difference between the measured L* values of the plastic film containing no fine composite pigments and the colored plastic film of the present invention; Δa* represents the difference between the measured a* values of the plastic film containing no fine composite pigments and the colored plastic film of the present invention; and Δb* represents the difference between the measured b* values of the plastic film containing no fine composite pigments and the colored plastic film of the present invention.

The smaller the ΔE* value, the more excellent the coloring effect of the colorant contained in the plastic film.

(15) The transparency of the plastic film using the fine composite pigments was expressed by the linear absorption calculated from a light transmittance of the above-prepared plastic film which was measured by a self-recording photoelectric spectrophotometer “UV-2100” (manufactured by SHIMADZU SEISAKUSHO CO., LTD.) according to the following formula:

Linear absorption(μm⁻¹)=ln(1/t)/FT

wherein t is the light transmittance (−) at λ(=600 nm); FT is a thickness (μm) of the plastic film tested.

The smaller the linear absorption, the higher the light transmittance and the higher the transparency, and further, the more the coloring property thereof is not deteriorated upon adding the colorant.

(16) The combustion efficiency of the plastic film was evaluated by combustion velocity, complete combustion percentage and low-temperature combustibility. The combustion velocity was determined as follows. That is, a 10-mg film piece was cut from the plastic film as formed, and heated at a temperature rise rate of 10° C./minute in an air flow supplied at a rate of 300 ml/minute to measure the weight change thereof using a thermal weight analyzing apparatus (manufactured by Seiko Denshi Kogyo Co., Ltd.). The combustion velocity was expressed by the time required from the initiation of rapid weight reduction to the termination thereof (it is considered that the combustion was caused during the time).

(17) The complete combustion percentage of the plastic film was expressed by the weight reduction percentage (%) (calculated as percentage per unit weight of combustible wastes) as measured at the time at which the rapid weight reduction was terminated in the above combustion test. It is considered that the higher the complete combustion percentage, the smaller the amount of cinders and residual ashes remaining after incineration.

(18) The low-temperature combustibility of the plastic film was expressed by the temperature at which the weight reduction thereof was no longer caused in the above combustion test. It is considered that the low-temperature combustibility means the temperature required for completely burning organic substances.

### Example 1

<Production of Fine Composite Pigments>

11.0 kg of fine goethite particles (particle shape: acicular shape; average major axis diameter: 0.0710 μm; average minor axis diameter: 0.0081 μm; aspect ratio: 8.8:1; geometrical standard deviation value: 1.38; BET specific surface area value: 159.8 m²/g; Al content: 0.83% by weight; L* value: 51.6; a* value: 31.4; b* value: 61.7; c* value: 69.2; hiding power: 152 cm²/g; heat resistance: 245° C.) were charged into an edge runner “MPUV-2 Model” (tradename, manufactured by MATSUMOTO CHUZO TEKKOSHO CO., LTD.). Then, a methyltriethoxysilane solution prepared by mixing and diluting 220 g of methyltriethoxysilane (tradename: “TSL8123”, produced by GE TOSHIBA SILICONE CO., LTD.) with 200 ml of ethanol, was added to the fine goethite particles while operating the edge runner, and the obtained mixture was mixed and stirred at a linear load of 392 N/cm (40 Kg/cm) and a stirring speed of 22 rpm for 20 minutes.

Next, 550 g of organic blue pigments C (kind: metal-free phthalocyanine blue; particle shape: granular shape; average major axis diameter: 0.10 μm; hiding power: 301 cm²/g; L* value: 16.9; a* value: 12.1; b* value: −28.8; heat resistance: 266° C.) were added to the fine goethite particles coated with methyltriethoxysilane for 10 minutes while operating the edge runner. Further, the resultant mixture was further mixed and stirred at a linear load of 392 N/cm (40 Kg/cm) and a stirring speed of 22 rpm for 20 minutes, thereby adhering the organic blue pigments C onto the coating layer composed of methyltriethoxysilane. The thus obtained composite pigments were heat-treated at 80° C. for 60 minutes using a dryer, thereby obtaining fine composite pigments composed of fine composite pigments.

It was confirmed that the obtained fine composite pigments were acicular particles having an average major axis diameter of 0.0716 μm; an average minor axis diameter of 0.0082 μm; an aspect ratio of 8.7:1; a geometrical standard deviation value of 1.39; a BET specific surface area value of 156.7 m²/g; a L* value of 32.4; an a* value of −7.1; a b* value of 1.4; a c* value of 7.2; a hiding power of 133 cm²/g; and a heat resistance of 250° C. Further, it was confirmed that the desorption percentage of the organic blue pigments was 6.6%; the coating amount of the organosilane compounds obtainable from methyltriethoxysilane was 0.30% by weight (calculated as Si); and the amount of the organic blue pigments adhered was 3.12% by weight (calculated as C, corresponding to 5.0 parts by weight based on 100 parts by weight of the fine goethite particles).

As a result of the observation using an electron micrograph, almost no organic blue pigments C were recognized, so that it was confirmed that a substantially whole amount of the organic blue pigments C added were adhered on the coating layer composed of the organosilane compounds obtainable from methyltriethoxysilane.

<Production of Plastic Film>

0.2 part by weight of the above-prepared fine composite pigments were added to 99.8 parts by weight of low-density polyethylene, and the obtained mixture was mixed and then extrusion-molded by an inflation method, thereby preparing a tubular film having a thickness of 30 μm. It was confirmed that the content of the fine composite pigments in the obtained film corresponded to 0.2% by weight, and the combustion efficiency, complete combustion percentage and low-temperature combustibility of the film were 1.35 minutes, 97.1% by weight and 452° C., respectively.

Core Particles 1 to 5:

As the core particles, the fine iron oxide hydroxide particles having properties as shown in Table 1 were prepared.

Core Particles 6:

20 kg of the fine acicular goethite particles as core particles 1 were added to 150 liters of water, thereby obtaining a slurry containing the fine acicular goethite particles. The pH value of the obtained re-dispersed slurry containing the fine acicular goethite particles was adjusted to 10.5 by using an aqueous sodium hydroxide solution, and then the concentration of the slurry was adjusted to 98 g/liter by adding water thereto. 150 liters of the slurry was heated to 60° C., and then mixed with 5444 ml of a 5.0 mol/liter sodium aluminate solution (corresponding to 5% by weight (calculated as Al) based on the weight of the fine acicular goethite particles). After allowing the obtained slurry to stand for 30 minutes, the pH value of the slurry was adjusted to 7.5 by using acetic acid. After further allowing the resultant slurry to stand for 30 minutes, the slurry was subjected to filtration, washing with water, drying and pulverization, thereby obtaining the fine acicular goethite particles whose surface was coated with hydroxides of aluminum.

Main production conditions are shown in Table 2, and various properties of the obtained surface-treated fine acicular goethite particles are shown in Table 3.

Core Particles 7 to 9:

The same procedure as defined above for the production of the core particles 5 was conducted except that the core particles 2 to 4 were used, and kind and amount of surface-coating material were changed variously, thereby obtaining fine iron oxide hydroxide particles coated with the surface-coating material.

Main production conditions are shown in Table 2, and various properties of the obtained surface-treated fine iron oxide hydroxide particles are shown in Table 3.

Meanwhile, in the column “kind of coating material” of “surface-treating step” in Table 2, “A” represents hydroxides of aluminum, and “S” represents oxides of silicon.

Organic Blue Pigments A to C:

As the organic blue pigments, there were prepared organic blue pigments having properties shown in Table 4.

Composite Pigments 1 to 11:

Fine composite pigments composed of fine composite pigments were produced by the same method as defined in Example 1 except that kind and amount of additives added in the coating step with alkoxysilanes or polysiloxanes, linear load and time of edge runner treatment conducted in the coating step with alkoxysilanes or polysiloxanes, kind and amount of organic blue pigments adhered in the step for forming an organic blue pigment coat, and linear load and time of edge runner treatment conducted in the step for forming an organic blue pigment coat, were changed variously.

Main production conditions are shown in Table 5, and various properties of the obtained fine composite pigments are shown in Table 6.

### Examples 2 to 9 and Comparative Examples 1 to 8

<Production of Plastic Film>

Plastic films each having a thickness of 30 μm were prepared by the same inflation extrusion-molding method as defined in Example 1 except that kinds and amounts of thermoplastic resin and fine composite pigments blended were changed variously.

Meanwhile, by comparing Example 8 and Comparative Example 2 with each other, it was confirmed that the plastic film produced using the fine composite pigments of the present invention was much more excellent in combustion velocity, complete combustion percentage, low-temperature combustibility than those produced using the conventional pigments.

Main production conditions are shown in Table 7, and various properties of the obtained plastic films are shown in Table 8.

### Example 10

<Production of Plastic Film>

100 parts by weight of low-density polyethylene was blended with 0.2 part by weight of the fine composite pigments obtained in Example 1 and 1.0 part by weight of quinacridone V-19, and the obtained mixture was formed into a tubular film having a thickness of 30 μm by an inflation extrusion-molding method. It was confirmed that the obtained colored plastic film showed a ΔL* value of 3.9; a Δa* value of 2.8; a Δb* value of 2.0; a coloring effect (ΔE* value) of colorant of 5.2; a combustion efficiency of 1.40 minutes; a complete combustion percentage of 97.1% by weight; and a low-temperature combustibility of 455° C.

### Examples 11 to 18 and Comparative Examples 9 to 18

<Production of Plastic Film>

The same procedure as defined in Example 10 was conducted except that kinds and amounts of thermoplastic resin, fine composite pigments and colorant blended were changed variously, thereby preparing films each having a thickness of 30 μm by an inflation extrusion-molding method.

Meanwhile, when Example 17 and Comparative Example 10 using the fine composite pigments and the resin at the same blending ratio, were compared with each other, it was confirmed that the colored plastic film of the present invention exhibited a more excellent coloring effect of colorant, and was remarkably more excellent in all of combustion velocity, complete combustion percentage and low-temperature combustibility as compared to those of the conventional plastic film.

Main production conditions are shown in Table 9, and various properties of the obtained colored plastic films are shown in Table 10.

### Example 19

<Production of Master Batch Pellets for Plastic Film>

100 parts by weight of low-density polyethylene resin “NOVATEC LD” (tradename; produced by Nippon Polychem Co., Ltd.) was kneaded with 11.1 parts by weight of the above composite pigment particles at 160° C. using a twin-screw kneader, and the obtained kneaded material was extruded and then cut into a cylindrical shape (average minor axis diameter: 3 mm, average diameter: 3 mm), thereby obtaining master batch pellets A.

<Production of Plastic Film>

100 parts by weight of linear low-density polyethylene pellets “SUMIKASEN L” (tradename; produced by Sumitomo Kagaku Co., Ltd.) were mixed with 2 parts by weight of the above master batch pellets A using a ribbon blender. Then, the obtained mixture was melt-kneaded and formed into a tubular film having a thickness of 30 μm (content of the fine composite pigment in the film: 0.2% by weight) using an inflation film-forming device. It was confirmed that the obtained film showed a L* value of 72.4; an a* value of −5.4; a b* value of 1.0; a c* value of 5.5; a transparency of 0.0060 μm⁻¹; a combustion efficiency of 1.16 minutes; a complete combustion percentage of 98.6%; and a low-temperature combustibility of 421° C.

### Examples 20 to 27 and Comparative Examples 19 to 23

<Production of Master Batch Pellets>

Master batch pellets were produced by the same method as defined in Example 19 except that kinds and amounts of fine composite pigments, and kind of binder resin were changed variously.

Main production conditions are shown in Table 11.

### Examples 28 to 35 and Comparative Examples 24 to 35

<Production of Plastic Film>

Plastic films each having a thickness of 30 μm were produced by the same inflation extrusion-molding method as defined in Example 19 except that kinds of master batch pellets and diluting resin, and blending ratio between polyolefin-based resin and fine composite pigments, were changed variously.

Main production conditions are shown in Table 12, and various properties of the obtained plastic films are shown in Table 13.

TABLE 1

| | | Properties of fine iron oxide | | | | | | |
|---|---|---|---|---|---|---|---|---|
| | | hydroxide particles | | | | | | |
| | | | | | | | | Inside Al |
| | Kind of fine | | Average | Average | | Geometrical | BET specific | content |
| Kind of | iron oxide | | major axis | minor axis | | standard | surface area | (calculated |
| core | hydroxide | | diameter | diameter | Aspect ratio | deviation value | value | as Al) |
| particles | particles | Shape | (μm) | (μm) | (−) | (−) | (m²/g) | (wt. %) |
| Core | Goethite | Acicular | 0.0813 | 0.0095 | 8.6:1 | 1.41 | 148.9 | — |
| particles | | | | | | | | |
| 1 | | | | | | | | |
| Core | Goethite | Spindle | 0.0571 | 0.0093 | 6.1:1 | 1.35 | 192.1 | 2.56 |
| particles | | | | | | | | |
| 2 | | | | | | | | |
| Core | Goethite | Acicular | 0.0763 | 0.0118 | 6.5:1 | 1.36 | 149.2 | 1.87 |
| particles | | | | | | | | |
| 3 | | | | | | | | |
| Core | Lepidocrocite | Rectangular | 0.0900 | 0.0179 | 5.0:1 | 1.40 | 100.4 | — |
| particles | | | | | | | | |
| 4 | | | | | | | | |
| Core | Goethite | Spindle | 0.2512 | 0.0369 | 6.8:1 | 1.55 | 68.5 | — |
| particles | | | | | | | | |
| 5 | | | | | | | | |

| | Properties of fine iron oxide | | | | | | | |
|---|---|---|---|---|---|---|---|---|
| | hydroxide particles | | | | | | | |
| | Composite oxide hydroxide | | | | | | | |
| | Amount of Al | Amount of Fe | | | | | | |
| | coated | coated | | | | | | |
| Kind of | (calculated as | (calculated as | Hue | | | | | |
| core | Al) | Fe) | L* value | a* value | b* value | C* value | Hiding power | Heat resistance |
| particles | (wt. %) | (wt. %) | (−) | (−) | (−) | (−) | (cm²/g) | (° C.) |
| Core | — | — | 50.1 | 29.4 | 54.2 | 61.7 | 171 | 192 |
| particles | | | | | | | | |
| 1 | | | | | | | | |
| Core | — | — | 52.6 | 29.6 | 57.0 | 64.2 | 144 | 246 |
| particles | | | | | | | | |
| 2 | | | | | | | | |
| Core | 1.31 | 11.00 | 54.3 | 27.3 | 58.9 | 64.9 | 158 | 270 |
| particles | | | | | | | | |
| 3 | | | | | | | | |
| Core | — | — | 48.4 | 33.6 | 59.4 | 68.2 | 209 | 189 |
| particles | | | | | | | | |
| 4 | | | | | | | | |
| Core | — | — | 56.6 | 18.4 | 51.3 | 54.5 | 1,711 | 193 |
| particles | | | | | | | | |
| 5 | | | | | | | | |

TABLE 2

| | | Surface-treating step | | | | | |
|---|---|---|---|---|---|---|---|
| | Kind of | Additives | | | Coating material | | |
| Core | core | | Calculated | Amount. | | Calculated | Amount |
| particles | particles | Kind | as | (wt. %) | Kind | as | (wt. %) |
| Core | Core | Sodium | Al | 5.0 | A | Al | 4.75 |
| particles 6 | particles 1 | aluminate | | | | | |
| Core | Core | Water glass #3 | SiO₂ | 2.0 | S | SiO₂ | 1.96 |
| particles 7 | particles 2 | | | | | | |
| Core | Core | Sodium | Al | 1.0 | A | Al | 0.98 |
| particles 8 | particles 3 | aluminate | | | | | |
| | | Water glass #3 | SiO₂ | 0.5 | S | SiO₂ | 0.49 |
| Core | Core | Aluminum | Al | 2.0 | A | Al | 1.96 |
| particles 9 | particles 4 | sulfate | | | | | |

TABLE 3

| | Properties of surface-treated fine iron | | | | | |
|---|---|---|---|---|---|---|
| | oxide hydroxide particles | | | | | |
| | | | | Geometrical | BET specific | |
| | Average major axis | Average minor axis | | standard | surface area | Hue |
| Kind of core | diameter | diameter | Aspect ratio | deviation value | value | L* value |
| particles | (μm) | (μm) | (−) | (−) | (m²/g) | (−) |
| Core | 0.0816 | 0.0098 | 8.3:1 | 1.42 | 154.2 | 51.1 |
| particles 6 | | | | | | |
| Core | 0.0572 | 0.0094 | 6.1:1 | 1.35 | 186.6 | 53.8 |
| particles 7 | | | | | | |
| Core | 0.0765 | 0.0120 | 6.4:1 | 1.37 | 152.9 | 55.2 |
| particles 8 | | | | | | |
| Core | 0.0901 | 0.0180 | 5.0:1 | 1.41 | 109.1 | 49.3 |
| particles 9 | | | | | | |

Properties of surface-treated fine iron
oxide hydroxide particles

| | Hue | | | Hiding | Heat |
|---|---|---|---|---|---|
| Kind of core | a* value | b* value | C* value | power | resistance |
| particles | (−) | (−) | (−) | (cm²/g) | (° C.) |
| Core | 29.1 | 54.3 | 61.6 | 166 | 222 |
| particles 6 | | | | | |
| Core | 29.3 | 57.6 | 64.6 | 140 | 253 |
| particles 7 | | | | | |
| Core | 26.1 | 58.1 | 63.7 | 152 | 274 |
| particles 8 | | | | | |
| Core | 34.0 | 60.2 | 69.1 | 207 | 208 |
| particles 9 | | | | | |

TABLE 4

| | Properties of organic blue pigments | | | | | | | |
|---|---|---|---|---|---|---|---|---|
| | | | Average particle | | Hue | | | Heat |
| Organic blue | | | diameter | Hiding power | L* value | a* value | b* value | resistance |
| pigments | Kind | Particle shape | (μm) | (cm²/g) | (−) | (−) | (−) | (° C.) |
| Organic blue | Copper phthalocyanine | Granular | 0.06 | 240 | 17.7 | 9.7 | −23.4 | 256 |
| pigments A | blue | | | | | | | |
| | (C.I. Pigment Blue) | | | | | | | |
| | (15:1) | | | | | | | |
| Organic blue | Copper phthalocyanine | Granular | 0.08 | 272 | 17.3 | 11.6 | −26.5 | 273 |
| pigments B | blue | | | | | | | |
| | (C.I. Pigment Blue) | | | | | | | |
| | (15:4) | | | | | | | |
| Organic blue | Metal-free | Granular | 0.10 | 301 | 16.9 | 12.1 | −28.8 | 266 |
| pigments C | phthalocyanine blue | | | | | | | |
| | (C.I. Pigment Blue 16) | | | | | | | |

TABLE 5

| | | Production of fine composite pigments | | | | | |
|---|---|---|---|---|---|---|---|
| | | Coating step with alkoxysilanes or | | | | | |
| | | polysiloxanes | | | | | |
| | | | | | | | Coating |
| | | | | | | | amount |
| Kind of fine | | Additives | | Edge runner treatment | | | (calculated |
| composite | | | Amount added | Linear load | | Time | as Si) |
| pigments | Kind of core particles | Kind | (wt. part) | (N/cm) | (Kg/cm) | (min.) | (wt. %) |
| Composite | Core particles 1 | Methyl triethoxysilane | 1.0 | 392 | 40 | 30 | 0.15 |
| pigments 1 | | | | | | | |
| Composite | Core particles 2 | Methyl trimethoxysilane | 0.5 | 588 | 60 | 20 | 0.10 |
| pigments 2 | | | | | | | |
| Composite | Core particles 3 | Phenyl triethoxysilane | 2.0 | 294 | 30 | 30 | 0.27 |
| pigments 3 | | | | | | | |
| Composite | Core particles 4 | Methyl hydrogen polysiloxane | 1.0 | 294 | 30 | 30 | 0.42 |
| pigments 4 | | | | | | | |
| Composite | Core particles 6 | Methyl triethoxysilane | 3.0 | 441 | 45 | 30 | 0.45 |
| pigments 5 | | | | | | | |
| Composite | Core particles 7 | Phenyl triethoxysilane | 1.0 | 588 | 60 | 20 | 0.13 |
| pigments 6 | | | | | | | |
| Composite | Core particles 8 | Methyl triethoxysilane | 1.5 | 735 | 75 | 20 | 0.23 |
| pigments 7 | | | | | | | |
| Composite | Core particles 9 | Methyl hydrogen polysiloxane | 1.0 | 588 | 60 | 40 | 0.42 |
| pigments 8 | | | | | | | |
| Composite | Core particles 1 | Methyl triethoxysilane | 1.0 | 588 | 60 | 20 | 0.15 |
| pigments 9 | | | | | | | |
| Composite | Core particles 1 | Methyl triethoxysilane | 1.0 | 588 | 60 | 20 | 0.15 |
| pigments 10 | | | | | | | |
| Composite | Core particles 5 | Methyl triethoxysilane | 1.0 | 588 | 60 | 20 | 0.15 |
| pigments 11 | | | | | | | |

Production of fine composite pigments
Step for forming organic blue pigment coat

| | | | | | | Amount |
|---|---|---|---|---|---|---|
| | Organic blue | | | | | adhered |
| Kind of | pigment | | | | | (calcu- |
| fine | | Amount | Edge runner treatment | | | lated |
| composite | | added | Linear load | | Time | as C) |
| pigments | Kind | (wt. part) | (N/cm) | (Kg/cm) | (min.) | (wt. %) |
| Composite | A | 10.0 | 588 | 60 | 20 | 6.04 |
| pigments 1 | | | | | | |
| Composite | B | 7.5 | 441 | 45 | 30 | 4.60 |
| pigments 2 | | | | | | |
| Composite | C | 5.0 | 588 | 60 | 30 | 3.11 |
| pigments 3 | | | | | | |
| Composite | A | 20.0 | 588 | 60 | 20 | 11.09 |
| pigments 4 | | | | | | |
| Composite | B | 3.0 | 735 | 75 | 20 | 1.89 |
| pigments 5 | | | | | | |
| Composite | C | 2.0 | 441 | 45 | 40 | 1.25 |
| pigments 6 | | | | | | |
| Composite | A | 7.5 | 490 | 50 | 20 | 4.61 |
| pigments 7 | | | | | | |
| Composite | C | 5.0 | 588 | 60 | 30 | 3.09 |
| pigments 8 | | | | | | |
| Composite | A | 25.0 | 588 | 60 | 20 | 13.26 |
| pigments 9 | | | | | | |
| Composite | A | 0.1 | 588 | 60 | 20 | 0.06 |
| pigments 10 | | | | | | |
| Composite | A | 5.0 | 588 | 60 | 20 | 3.10 |
| pigments 11 | | | | | | |

TABLE 6

| | Properties of fine composite pigments | | | | | |
|---|---|---|---|---|---|---|
| | | | | Geometrical | BET specific | |
| Kind of fine | Average major axis | Average minor axis | | standard | surface area | Hue |
| composite | diameter | diameter | Aspect ratio | deviation value | value | L* value |
| pigments | (μm) | (μm) | (−) | (−) | (m²/g) | (−) |
| Composite | 0.0825 | 0.0100 | 8.3:1 | 1.41 | 142.2 | 31.9 |
| pigments 1 | | | | | | |
| Composite | 0.0580 | 0.0097 | 6.0:1 | 1.36 | 189.6 | 33.2 |
| pigments 2 | | | | | | |
| Composite | 0.0769 | 0.0121 | 6.4:1 | 1.36 | 144.8 | 36.3 |
| pigments 3 | | | | | | |
| Composite | 0.0918 | 0.0188 | 4.9:1 | 1.41 | 96.0 | 26.8 |
| pigments 4 | | | | | | |
| Composite | 0.0818 | 0.0100 | 8.2:1 | 1.42 | 151.1 | 32.1 |
| pigments 5 | | | | | | |
| Composite | 0.0574 | 0.0095 | 6.0:1 | 1.36 | 180.1 | 34.6 |
| pigments 6 | | | | | | |
| Composite | 0.0777 | 0.0125 | 6.2:1 | 1.37 | 149.6 | 35.3 |
| pigments 7 | | | | | | |
| Composite | 0.0906 | 0.0183 | 5.0:1 | 1.41 | 100. 8 | 34.2 |
| pigments 8 | | | | | | |
| Composite | 0.0833 | 0.0106 | 7.9:1 | 1.42 | 116.8 | 21.5 |
| pigments 9 | | | | | | |
| Composite | 0.0813 | 0.0095 | 8.6:1 | 1.41 | 147.2 | 49.1 |
| pigments 10 | | | | | | |
| Composite | 0.2517 | 0.0371 | 6.8:1 | 1.55 | 63.1 | 32.3 |
| pigments 11 | | | | | | |

Properties of fine composite pigments

| Kind of fine | Hue | | | Hiding | Heat |
|---|---|---|---|---|---|
| composite | a* value | b* value | C* value | power | resistance |
| pigments | (−) | (−) | (−) | (cm²/g) | (° C.) |
| Composite | −14.2 | 3.8 | 14.7 | 177 | 223 |
| pigments 1 | | | | | |
| Composite | −11.2 | 5.2 | 12.3 | 152 | 259 |
| pigments 2 | | | | | |
| Composite | −8.6 | 6.1 | 10.5 | 160 | 275 |
| pigments 3 | | | | | |
| Composite | −16.9 | −1.1 | 16.9 | 215 | 229 |
| pigments 4 | | | | | |
| Composite | −13.6 | 2.6 | 13.8 | 170 | 236 |
| pigments 5 | | | | | |
| Composite | −9.3 | 4.9 | 10.5 | 142 | 259 |
| pigments 6 | | | | | |
| Composite | −10.8 | 6.6 | 12.7 | 158 | 284 |
| pigments 7 | | | | | |
| Composite | −7.3 | 3.8 | 8.2 | 209 | 224 |
| pigments 8 | | | | | |
| Composite | −27.4 | −8.6 | 28.7 | 189 | 221 |
| pigments 9 | | | | | |
| Composite | 27.6 | 53.3 | 60.0 | 172 | 196 |
| pigments 10 | | | | | |
| Composite | −11.5 | 19.4 | 22.6 | 1,723 | 215 |
| pigments 11 | | | | | |

TABLE 7

| | Production of plastic film | | | |
|---|---|---|---|---|
| | Fine composite pigments | | Resin | |
| | | Amount | | Amount |
| | | blended | | blended |
| Examples and | | (wt. | | (wt. |
| Comparative Examples | Kind | part) | Kind | part) |
| Example 2 | Fine composite pigments 1 | 0.100 | Low-density polyethylene | 99.900 |
| Example 3 | Fine composite pigments 2 | 0.300 | Polypropylene | 99.700 |
| Example 4 | Fine composite pigments 3 | 1.000 | High-density polyethylene | 99.000 |
| Example 5 | Fine composite pigments 4 | 1.500 | Polypropylene | 98.500 |
| Example 6 | Fine composite pigments 5 | 1.800 | Low-density polyethylene | 98.200 |
| Example 7 | Fine composite pigments 6 | 0.050 | Polypropylene | 99.950 |
| Example 8 | Fine composite pigments 7 | 0.020 | Low-density polyethylene | 99.980 |
| Example 9 | Fine composite pigments 8 | 0.500 | Polypropylene | 99.500 |
| Comparative Example 1 | Core particles 1 | 0.100 | Low-density polyethylene | 99.900 |
| Comparative Example 2 | Core particles 5 | 0.020 | Low-density polyethylene | 99.980 |
| Comparative Example 3 | Core particles 5 | 0.500 | Polypropylene | 99.500 |
| Comparative Example 4 | Fine composite pigments 9 | 1.000 | High-density polyethylene | 99.000 |
| Comparative Example 5 | Fine composite pigments 10 | 0.500 | Polypropylene | 99.500 |
| Comparative Example 6 | Fine composite pigments 11 | 0.200 | Low-density polyethylene | 99.800 |
| Comparative Example 7 | Fine composite pigments 1 | 0.001 | Low-density polyethylene | 99.999 |
| Comparative Example 8 | Fine composite pigments 1 | 5.000 | Low-density polyethylene | 95.000 |
| Comparative Example 9 | — | — | Low-density polyethylene | 100.000 |
| Comparative Example 10 | — | — | Polypropylene | 100.000 |

TABLE 8

| | Properties of plastic film | | | | | | | |
|---|---|---|---|---|---|---|---|---|
| | | | | | | | Complete | |
| | | | | | Transparency | Combustion | combustion | Low-temperature |
| | Hue | | | | (linear | velocity | percentage | combustibility |
| Examples and | L* value | a* value | b* value | C* value | absorption) | (in air) | (in air) | (in air) |
| Comparative Examples | (−) | (−) | (−) | (−) | (μm⁻¹) | (min) | (wt. %) | (° C.) |
| Example 2 | 71.3 | −5.6 | 2.1 | 6.0 | 0.0063 | 1.50 | 97.0 | 470 |
| Example 3 | 76.3 | −4.3 | 3.4 | 5.5 | 0.0069 | 1.51 | 98.2 | 435 |
| Example 4 | 81.3 | −3.8 | 4.6 | 6.0 | 0.0079 | 1.15 | 97.8 | 453 |
| Example 5 | 68.1 | −7.3 | −2.1 | 7.6 | 0.0106 | 1.34 | 98.6 | 420 |
| Example 6 | 78.3 | −3.1 | 6.3 | 7.0 | 0.0119 | 1.26 | 97.2 | 417 |
| Example 7 | 86.5 | −2.1 | 5.6 | 6.0 | 0.0054 | 1.95 | 97.8 | 447 |
| Example 8 | 74.8 | −4.6 | 3.2 | 5.6 | 0.0056 | 1.98 | 94.5 | 490 |
| Example 9 | 80.3 | −4.3 | 4.6 | 6.3 | 0.0064 | 1.19 | 98.3 | 436 |
| Comparative Example 1 | 79.9 | 12.2 | 20.7 | 24.0 | 0.0063 | 1.49 | 97.1 | 468 |
| Comparative Example 2 | 76.2 | 13.2 | 23.0 | 26.5 | 0.0653 | 3.90 | 80.9 | 515 |
| Comparative Example 3 | 73.6 | 15.1 | 29.4 | 33.1 | 0.1238 | 1.91 | 98.0 | 442 |
| Comparative Example 4 | 43.8 | −21.6 | −19.6 | 29.2 | 0.0143 | 1.20 | 97.4 | 458 |
| Comparative Example 5 | 80.1 | 11.8 | 16.5 | 20.3 | 0.0069 | 1.40 | 98.4 | 429 |
| Comparative Example 6 | 76.1 | −7.2 | 12.7 | 14.6 | 0.1124 | 1.78 | 96.3 | 478 |
| Comparative Example 7 | 88.1 | 1.3 | 3.8 | 4.0 | 0.0052 | 4.07 | 81.0 | 527 |
| Comparative Example 8 | 51.2 | −13.7 | 3.3 | 14.1 | 0.0713 | 1.22 | 97.5 | 412 |
| Comparative Example 9 | 89.4 | −0.2 | −0.5 | 0.5 | 0.0048 | 4.26 | 82.1 | 532 |
| Comparative Example 10 | 90.2 | −0.3 | −0.7 | 0.8 | 0.0050 | 4.50 | 86.0 | 518 |

TABLE 9

| | Production of colored plastic film | | | | | |
|---|---|---|---|---|---|---|
| | Fine iron oxide hydroxide particles | | Resin | | Colorant | |
| | | Amount | | Amount | | Amount |
| Examples and | | blended | | blended | | blended |
| Comparative Examples | Kind | (wt. part) | Kind | (wt. part) | Kind | (wt. part) |
| Example 11 | Composite particles 1 | 0.100 | Low-density polyethylene | 100.000 | Phthalocyanine blue B-15 | 0.020 |
| Example 12 | Composite particles 2 | 0.300 | polypropylene | 100.000 | Quinacridone V-19 | 0.500 |
| Example 13 | Composite particles 3 | 1.000 | High-density polyethylene | 100.000 | Red iron oxide 100ED | 0.500 |
| Example 14 | Composite particles 4 | 1.500 | polypropylene | 100.000 | Carbon black BK-7 | 1.000 |
| Example 15 | Composite particles 5 | 1.800 | Low-density polyethylene | 100.000 | Phthalocyaninegreen G-7 | 1.000 |
| Example 16 | Composite particles 6 | 0.050 | polypropylene | 100.000 | Disazo yellow Y-83 | 1.500 |
| Example 17 | Composite particles 7 | 0.020 | Low-density polyethylene | 100.000 | Titanium oxide W-6 | 1.800 |
| Example 18 | Composite particles 8 | 0.500 | polypropylene | 100.000 | Phthalocyanine blue B-15 | 0.500 |
| Comparative Example 10 | Core particles 1 | 0.100 | Low-density polyethylene | 100.000 | Phthalocyanine blue B-15 | 0.100 |
| Comparative Example 11 | Core particles 5 | 0.020 | Low-density polyethylene | 100.000 | Titanium oxide W-6 | 1.800 |
| Comparative Example 12 | Core particles 5 | 0.500 | polypropylene | 100.000 | Phthalocyaninegreen G-7 | 1.000 |
| Comparative Example 13 | Composite particles 10 | 0.500 | polypropylene | 100.000 | Phthalocyanine blue B-15 | 0.500 |
| Comparative Example 14 | Composite particles 11 | 0.200 | Low-density polyethylene | 100.000 | Phthalocyanine blue B-15 | 1.000 |
| Comparative Example 15 | Composite particles 1 | 0.001 | Low-density polyethylene | 100.000 | Carbon black BK-7 | 1.000 |
| Comparative Example 16 | Composite particles 1 | 5.000 | Low-density polyethylene | 100.000 | Titanium oxide W-6 | 1.000 |
| Comparative Example 17 | — | — | Low-density polyethylene | 100.000 | Carbon black BK-7 | 1.000 |
| Comparative Example 18 | — | — | polypropylene | 100.000 | Quinacridone V-19 | 0.500 |

TABLE 10

| | Properties of colored plastic film | | | | | | |
|---|---|---|---|---|---|---|---|
| | | | | | | Complete | |
| | | | | | Combustion | combustion | Low-temperature |
| | Hue | | | Coloring property | velocity | percentage | combustibility |
| Examples and | ΔL* value | Δa* value | Δb* value | (ΔE* value) | (in air) | (in air) | (in air) |
| Comparative Examples | (−) | (−) | (−) | (−) | (min) | (wt. %) | (° C.) |
| Example 11 | 5.1 | 3.1 | 3.8 | 7.1 | 1.52 | 97.0 | 475 |
| Example 12 | 4.7 | 4.0 | 2.3 | 6.6 | 1.48 | 98.0 | 440 |
| Example 13 | 4.3 | 3.6 | 1.8 | 5.9 | 1.15 | 97.6 | 450 |
| Example 14 | 3.4 | 1.3 | 1.5 | 3.9 | 1.32 | 98.4 | 420 |
| Example 15 | 2.9 | 0.9 | 1.1 | 3.2 | 1.30 | 97.0 | 420 |
| Example 16 | 3.2 | 3.4 | 1.7 | 5.0 | 1.90 | 97.0 | 445 |
| Example 17 | 3.1 | 2.5 | 2.2 | 4.5 | 1.93 | 94.0 | 490 |
| Example 18 | 4.3 | 2.2 | 2.0 | 5.2 | 1.52 | 98.1 | 435 |
| Comparative Example 10 | 7.8 | 5.7 | 8.2 | 12.7 | 1.50 | 97.5 | 466 |
| Comparative Example 11 | 5.4 | 5.1 | 9.7 | 12.2 | 3.70 | 83.0 | 515 |
| Comparative Example 12 | 9.5 | 5.2 | 4.4 | 11.7 | 1.89 | 97.9 | 445 |
| Comparative Example 13 | 8.7 | 6.6 | 8.9 | 14.1 | 1.37 | 98.4 | 430 |
| Comparative Example 14 | 7.6 | 5.9 | 8.4 | 12.8 | 1.80 | 96.5 | 473 |
| Comparative Example 15 | 1.6 | 0.7 | 0.6 | 1.8 | 4.10 | 81.5 | 531 |
| Comparative Example 16 | 12.3 | 8.1 | 8.3 | 16.9 | 1.25 | 97.0 | 414 |
| Comparative Example 17 | — | — | — | — | 4.15 | 83.9 | 535 |
| Comparative Example 18 | — | — | — | — | 4.50 | 87.3 | 515 |

TABLE 11

| | Production of master batch pellets | | | | | |
|---|---|---|---|---|---|---|
| | Fine composite pigments | | | | | |
| | | Amount | | | | |
| | | blended based | | | | Average minor |
| | | on 100 parts | | | | axis diameter |
| Examples and | | by weight of | | | Average major | (average |
| Comparative | | resin | Kind of binder | | axis diameter | diameter) |
| Examples | Kind | (wt. part) | resin | Shape | (mm) | (mm) |
| Example 20 | Composite | 11.1 | Low-density | Cylindrical | 4.0 | 3.0 |
| | pigments 1 | | polyethylene | | | |
| Example 21 | Composite | 25.0 | Polypropylene | Cylindrical | 2.5 | 4.0 |
| | pigments 2 | | | | | |
| Example 22 | Composite | 25.0 | High-density | Cylindrical | 3.5 | 3.5 |
| | pigments 3 | | polyethylene | | | |
| Example 23 | Composite | 11.1 | Low-density | Cylindrical | 3.5 | 2.5 |
| | pigments 4 | | polyethylene | | | |
| Example 24 | Composite | 42.9 | Low-density | Cylindrical | 2.0 | 4.0 |
| | pigments 5 | | polyethylene | | | |
| Example 25 | Composite | 1.0 | Low-density | Cylindrical | 4.5 | 3.0 |
| | pigments 6 | | polyethylene | | | |
| Example 26 | Composite | 11.1 | Low-density | Cylindrical | 4.0 | 3.5 |
| | pigments 7 | | polyethylene | | | |
| Example 27 | Composite | 5.3 | Linear Low- | Cylindrical | 2.5 | 4.0 |
| | pigments 8 | | density polyethylene | | | |
| Comparative | Composite | 0.7 | Low-density | Cylindrical | 1.5 | 5.0 |
| Example 19 | pigments 10 | | polyethylene | | | |
| Comparative | Composite | 45.0 | Low-density | Cylindrical | 5.5 | 2.0 |
| Example 20 | pigments 11 | | polyethylene | | | |
| Comparative | Core | 25.0 | Low-density | Cylindrical | 3.0 | 3.5 |
| Example 21 | particles 1 | | polyethylene | | | |
| Comparative | Core | 25.0 | Low-density | Cylindrical | 3.5 | 3.0 |
| Example 22 | particles 5 | | polyethylene | | | |

TABLE 12

| | Production of plastic film | | | |
|---|---|---|---|---|
| | Master batch pellets | | Diluting binder resin | |
| Examples and | | Amount | | Amount |
| Comparative | | (wt. | | (wt. |
| Examples | Kind | part) | Kind | part) |
| Example 28 | Example 20 | 3.1 | Low-density | 100 |
| | | | polyethylene | |
| Example 29 | Example 21 | 2.6 | Polypropylene | 100 |
| Example 30 | Example 22 | 8.1 | High-density | 100 |
| | | | polyethylene | |
| Example 31 | Example 23 | 1.0 | Low-density | 100 |
| | | | polyethylene | |
| Example 32 | Example 24 | 7.2 | Linear low-density | 100 |
| | | | polyethylene | |
| Example 33 | Example 25 | 2.0 | Polypropylene | 100 |
| Example 34 | Example 26 | 11.1 | Low-density | 100 |
| | | | polyethylene | |
| Example 35 | Example 27 | 0.2 | Linear low-density | 100 |
| | | | polyethylene | |
| Comparative | Comparative | 16.7 | Linear low-density | 100 |
| Example 23 | Example 19 | | polyethylene | |
| Comparative | Comparative | 0.16 | Linear low-density | 100 |
| Example 24 | Example 20 | | polyethylene | |
| Comparative | Comparative | 1.6 | Polypropylene | 100 |
| Example 25 | Example 20 | | | |
| Comparative | Comparative | 5.3 | Linear low-density | 100 |
| Example 26 | Example 21 | | polyethylene | |
| Comparative | Comparative | 8.1 | Low-density | 100 |
| Example 27 | Example 22 | | polyethylene | |

TABLE 13

| | Properties of plastic film | | | | | | | | |
|---|---|---|---|---|---|---|---|---|---|
| | Content of | | | | | | | | |
| | fine | Hue | | | | | | Complete combustion | Low-temperature |
| Examples and | composite | L* | a* | b* | c* | Transparency | Combustion velocity | percentage | combustibility |
| Comparative | pigments | value | value | value | value | (linear absorption) | (in air) | (in air) | (in air) |
| Examples | (%) | (−) | (−) | (−) | (−) | (μm⁻¹) | (min) | (wt. %) | (° C.) |
| Example 28 | 0.3 | 70.5 | −6.0 | 2.2 | 6.4 | 0.0062 | 1.50 | 96.2 | 447 |
| Example 29 | 0.5 | 76.0 | −4.5 | 3.8 | 5.9 | 0.0068 | 1.42 | 97.6 | 435 |
| Example 30 | 1.5 | 80.8 | −4.1 | 4.9 | 6.4 | 0.0079 | 1.21 | 98.4 | 418 |
| Example 31 | 0.1 | 71.3 | −4.4 | −1.1 | 4.5 | 0.0058 | 1.62 | 96.0 | 462 |
| Example 32 | 2.0 | 77.9 | −3.3 | 6.4 | 7.2 | 0.0085 | 1.10 | 98.8 | 414 |
| Example 33 | 0.02 | 7.1 | −1.6 | 5.0 | 5.2 | 0.0053 | 1.84 | 95.0 | 474 |
| Example 34 | 1.0 | 72.4 | −5.0 | 3.6 | 6.2 | 0.0070 | 1.28 | 98.0 | 425 |
| Example 35 | 0.01 | 82.7 | −3.8 | 4.2 | 5.7 | 0.0052 | 1.92 | 94.6 | 482 |
| Comparative | 0.1 | 81.1 | 11.0 | 15.6 | 19.1 | 0.0066 | 1.82 | 96.0 | 476 |
| Example 23 | | | | | | | | | |
| Comparative | 0.05 | 77.0 | −6.9 | 11.7 | 13.6 | 0.1011 | 1.90 | 95.2 | 488 |
| Example 24 | | | | | | | | | |
| Comparative | 0.5 | 75.3 | −8.3 | 12.7 | 15.2 | 0.1397 | 1.58 | 97.0 | 452 |
| Example 25 | | | | | | | | | |
| Comparative | 1.0 | 80.2 | 15.8 | 24.3 | 29.0 | 0.0081 | 1.52 | 97.5 | 465 |
| Example 26 | | | | | | | | | |
| Comparative | 1.5 | 83.5 | 17.7 | 29.1 | 34.1 | 0.1514 | 1.64 | 97.8 | 448 |
| Example 27 | | | | | | | | | |

What is claimed is:

1. A plastic film comprising:
a thermoplastic resin and
fine composite pigments in an amount of 0.01 to 2.0% by weight, which have an average major axis diameter from 0.005 to less than 0.1 μm, and comprise:
iron oxide hydroxide particle as non-magnetic core particle,
a coating formed on surface of said iron oxide hydroxide particle, comprising at least one organosilicon compound selected from the group consisting of:
(1) organosilane compounds obtainable from alkoxysilane compounds, and
(2) polysiloxanes or modified polysiloxanes, and
an organic blue pigment coat formed on said coating comprising said organosilicon compound, in an amount of 1 to 20 parts by weight based on 100 parts by weight of said iron oxide hydroxide particles.

2. A plastic film according to claim 1, wherein a coating layer comprising at least one compound selected from the group consisting of hydroxides of aluminum, oxides of aluminum, hydroxides of silicon and oxides of silicon, is disposed between the surface of said iron oxide hydroxide particle and said coating comprising said organosilicon compound.

3. A plastic film according to claim 1, wherein said modified polysiloxanes are ones selected from the group consisting of:
(A) polysiloxanes modified with at least one compound selected from the group consisting of polyethers, polyesters and epoxy compounds, and
(B) polysiloxanes whose molecular terminal is modified with at least one group selected from the group consisting of carboxylic acid groups, alcohol groups and a hydroxyl group.

4. A plastic film according to claim 1, wherein said alkoxysilane compound is represented by the general formula (I):
R¹ₐSiX₄₋ₐ (I)
wherein R¹ is C₆H₅—, (CH₃)₂CHCH₂— or n-C_{b}H_{2b+1}— (wherein b is an integer from 1 to 18); X is CH₃O— or C₂H₅O—; and a is an integer from 0 to 3.

5. A plastic film according to claim 4, wherein said alkoxysilane compound is methyltriethoxysilane, dimethyldiethoxysilane, phenyltriethoxysilane, diphenyldiethoxysilane, methyltrimethoxysilane, dimethyldimethoxysilane, phenyltrimethoxysilane, diphenyldimethoxysilane, isobutyltrimethoxysilane or decyltrimethoxysilane.

6. A plastic film according to claim 1, wherein said polysiloxanes are represented by the general formula (II): 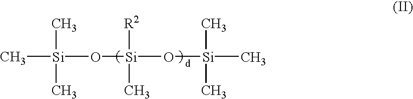
wherein R² is H— or CH₃—, and d is an integer from 15 to 450.

7. A plastic film according to claim 6, wherein said polysiloxanes are ones having methyl hydrogen siloxane units.

8. A plastic film according to claim 3, wherein said polysiloxanes modified with at least one compound selected from the group consisting of polyethers, polyesters and epoxy compounds are represented by the general formula (III), (IV) or (V): 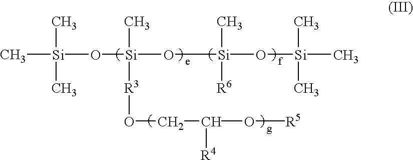
wherein R³ is —(—CH₂—)ₕ—; R⁴ is —(—CH₂—)ᵢ—CH₃; R⁵ is —OH, —COOH, —CH═CH₂, —C(CH₃)═CH₂ or —(—CH₂—)ⱼ—CH₃; R⁶ is —(—CH₂—)ₖ—CH₃; g and h are an integer from 1 to 15; i, j and k are an integer from 0 to 15; e is an integer from 1 to 50; and f is an integer from 1 to 300; 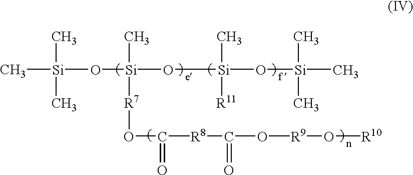
wherein R⁷, R⁸ and R⁹ are —(—CH₂—)_{q}— and may be the same or different; R¹⁰ is —OH, —COOH, —CH═CH₂, —C(CH₃)═CH₂ or —(—CH₂—)ᵣ—CH₃; R¹¹ is —(—CH₂—)ₛ—CH₃; n and q are an integer from 1 to 15; r and s are an integer from f 0 to 15; e′ is an integer from 1 to 50; and f′ is an integer from 1 to 300; or 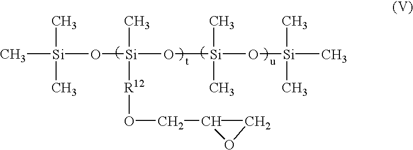
wherein R¹² is —(—CH₂—)ᵥ—; v is an integer from 1 to 15; t is an integer from 1 to 50; and u is an integer from 1 to 300.

9. A plastic film according to claim 3, wherein said polysiloxanes whose molecular terminal is modified with at least one group selected from the group consisting of carboxylic acid groups, alcohol groups and hydroxyl groups are represented by the general formula (VI): 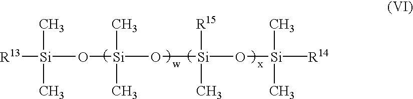
wherein R¹³ and R¹⁴ are —OH, R¹⁶OH or R¹⁷COOH and may be the same or different; R¹⁵ is —CH₃ or —C₆H₅; R¹⁶ and R¹⁷ are —(—CH₂—)_{y}—; y is an integer from 1 to 15; w is an integer from 1 to 200; and x is an integer from 0 to 100.

10. A plastic film according to claim 1, wherein the amount of said coating organosilicon compounds is 0.02 to 5.0% by weight, calculated as Si, based on the total weight of the organosilicon compounds and said acicular hematite particles or acicular iron oxide hydroxide particles.

11. A plastic film according to claim 1, wherein said organic blue pigment is phthalocyanine-based pigment and alkali blue.

12. A plastic film according to claim 11, wherein said phthalocyanine-based pigment is a phthalocyanine blue pigment and a metal free phthalocyanine blue pigment.

13. A plastic film according to claim 1, said fine composite particles have an aspect ratio of 2.0:1 to 20.0:1, a BET specific surface area of 50 to 300 m²/g and a geometrical standard deviation value of the average major axis diameter of not more than 1.8.

14. A plastic film according to claim 1, wherein said fine composite particles have a L* value of 25 to 80; an a* value of −20 to +20; a b* value of −20 to +20; a c* value of 0 to 20; a heat resisting temperature higher by +5 to +40° C. than a heat-resisting temperature of the fine composite pigments as the core particles; and a hiding power of less than 600 cm²/g.

15. A plastic film according to claim 1, having a thickness of 5 to 300 μm, a linear absorption of not more than 0.050 μm⁻¹ at a wavelength of 600 nm, and a C* value of 0 to 18.

16. A plastic film according to claim 1, having a combustion velocity in air of not more than 2.5 minutes, a complete combustion percentage in air of not less than 90% by weight, and a low-temperature combustibility in air of not more than 510° C.

17. A plastic film according to claim 1, which further comprises a colorant of 0.01 to 2.0% by weight based on the weight of the thermoplastic resin.

18. A shopping bag produced from the plastic film as defined in claim 1.

19. A garbage bag produced from the plastic film as defined in claim 1.

20. A process for producing the plastic film as defined in claim 1, comprising:
mixing a binder resin comprising a polyolefin-based resin with fine composite pigments in an amount of 1 to 43 parts by weight based on 100 parts by weight of the binder resin, which have an average major axis diameter from 0.005 to less than 0.1 μm, and comprise:
iron oxide hydroxide particle as non-magnetic core particle,
a coating formed on surface of said iron oxide hydroxide particle, comprising at least one organosilicon compound selected from the group consisting of:
(1) organosilane compounds obtainable from alkoxysilane compounds, and
(2) polysiloxanes or modified polysiloxanes, and
an organic blue pigment coat formed on said coating comprising said organosilicon compound, in an amount of 1 to 20 parts by weight based on 100 parts by weight of said iron oxide hydroxide particles, to produce master batch pellets; and
melt-kneading the obtained master batch pellets and a diluting binder resin comprising a polyolefin-based resin so that the content of the fine composite pigments in the plastic film become 0.01 to 2.0% by weight, and then forming into a film.

21. A plastic film having a thickness of 5 to 300 μm, a linear absorption of not more than 0.050 μm⁻¹ at a wavelength of 600 nm, a C* value of 0 to 18, a combustion velocity in air of not more than 2.5 minutes, a complete combustion percentage in air of not less than 90% by weight, and a low-temperature combustibility in air of not more than 510° C.;
which comprises:
a thermoplastic resin and
fine composite pigments in an amount of 0.01 to 2.0% by weight, which have an average major axis diameter from 0.005 to less than 0.1 μm, and comprise:
iron oxide hydroxide particle as non-magnetic core particle,
a coating formed on surface of said iron oxide hydroxide particle, comprising at least one organosilicon compound selected from the group consisting of:
(1) organosilane compounds obtainable from alkoxysilane compounds, and
(2) polysiloxanes or modified polysiloxanes, and
an organic blue pigment coat formed on said coating comprising said organosilicon compound, in an amount of 1 to 20 parts by weight based on 100 parts by weight of said iron oxide hydroxide particles.
